(19) United States
(12) Patent Application Publication
(10) Pub. No.: US 2024/0034234 A1
(43) Pub. Date: Feb. 1, 2024

(54) WARNING DEVICE FOR A WARNING DEVICE DEPLOYMENT SYSTEM

(71) Applicant: Kodiak Robotics, Inc., Mountain View, CA (US)

(72) Inventors: Joseph Gagliano, Santa Clara, CA (US); Monica Darwish, San Francisco, CA (US); Albert Moser, Mountain View, CA (US); Jamie Hoffacker, San Carlos, CA (US)

(21) Appl. No.: 17/816,191

(22) Filed: Jul. 29, 2022

(51) Int. Cl. B60Q 7/02; B60Q 1/50; B60Q 1/52; G09F 13/16; E01F 9/608; E01F 9/619; E01F 9/646; E01F 9/654; E01F 9/70

(52) U.S. Cl. CPC B60Q 7/02; B60Q 1/525; B60Q 1/52; B60Q 1/507; G09F 13/16; E01F 9/608; E01F 9/619; E01F 9/646; E01F 9/654; E01F 9/70

(57) ABSTRACT

A warning device for a warning device deployment system for an autonomous vehicle. The warning device includes a tetrahedron frame having four triangular faces and at least one reflective material on the tetrahedron frame. The tetrahedron frame defines an expanded shape of the warning device. The warning device is self-expandable such that the warning device is compactable to a reduced volume when the warning device is stored in the warning device deployment system and expandable to the expanded shape when the warning device is deployed from the warning device deployment system. A warning device deployment system includes one or more warning device deployment mechanisms attached to the autonomous vehicle and the one or more warning devices stored in the one or more warning device deployment mechanisms. The one or more warning devices are deployed from the one or more warning device deployment mechanisms.

### CROSS REFERENCE TO RELATED APPLICATIONS

The present application is related to co-pending U.S. Application Attorney Docket No. 143805.564203, filed Jul. 29, 2022, and U.S. Application Attorney Docket No. 143805.565107, filed Jul. 29, 2022, the entire contents of each of which are hereby incorporated by reference in their entireties.

### TECHNICAL FIELD

The present disclosure relates to a warning device for a warning device deployment system.

### BACKGROUND

Vehicles, such as cars, trucks, motorcycles, or the like, may encounter situations in which the vehicle needs to pull over and stop on a road or on the shoulder of the road. For example, a component of the vehicle may fail or otherwise may stop working, and the vehicle needs to be pulled over out of traffic for safety. When the vehicle stops on the road or the side of the road, triangles or flares, for example, may be required to be setup about the vehicle to notify other road users of the stopped vehicle so as to prevent crashes and accidents.

### BRIEF SUMMARY

A warning device for a warning device deployment system for an autonomous vehicle. The warning device comprising a tetrahedron frame having four triangular faces, and at least one reflective material on the tetrahedron frame. The tetrahedron frame defining an expanded shape of the warning device. The warning device being self-expandable such that the warning device is compactable to a reduced volume when the warning device is stored in the warning device deployment system and expandable to the expanded shape when the warning device is deployed from the warning device deployment system.

A warning device deployment system for an autonomous vehicle. The warning device deployment system comprising one or more warning device deployment mechanisms attached to the autonomous vehicle, and one or more warning devices stored in the one or more warning device deployment mechanisms. The one or more warning devices being deployed from the one or more warning device deployment mechanisms, the one or more warning devices comprising a tetrahedron frame having four triangular faces, and at least one reflective material on the tetrahedron frame. The tetrahedron frame defining an expanded shape of the one or more warning devices. The one or more warning devices being self-expandable such that the one or more warning devices are compactable to a reduced volume when the one or more warning devices are stored in the one or more warning device deployment mechanisms and expandable to the expanded shape when the one or more warning devices are deployed from the one or more warning device deployment mechanisms.

An autonomous vehicle comprising one or more warning device deployment mechanisms attached to the autonomous vehicle, and one or more warning devices stored in the one or more warning device deployment mechanisms. The one or more warning devices being deployed from the one or more warning device deployment mechanisms. The one or more warning devices comprising a tetrahedron frame having four triangular faces, and at least one reflective material on the tetrahedron frame. The tetrahedron frame defining an expanded shape of the warning device. The one or more warning devices being self-expandable such that the one or more warning devices are compactable to a reduced volume when the one or more warning devices are stored in the one or more warning device deployment mechanisms and expandable to the expanded shape when the one or more warning devices are deployed from the one or more warning device deployment mechanisms.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, and/or structurally similar elements.

FIG. 1 illustrates a schematic, side view of an autonomous vehicle including a warning device deployment system, according to an embodiment of the present disclosure.

FIG. 2A illustrates a schematic, top plan view of the autonomous vehicle of FIG. 1 including a warning device deployment system, according to an embodiment of the present disclosure.

FIG. 2B illustrates a schematic, rear end view of the autonomous vehicle of FIG. 1 including a warning device deployment system, according to an embodiment of the present disclosure.

FIG. 3 illustrates an enlarged schematic, rear end view of a portion of the autonomous vehicle of FIG. 1 including a detailed view of the warning device deployment system, according to an embodiment of the present disclosure.

FIG. 4 illustrates an enlarged schematic, rear end view of a portion of the autonomous vehicle of FIG. 1 including a detailed view of another warning device deployment system, according to another embodiment of the present disclosure.

FIG. 5A illustrates a schematic view of a warning device deployment mechanism for a warning device deployment in a stored state, according to an embodiment of the present disclosure.

FIG. 5B illustrates a schematic view of the warning device deployment mechanism of FIG. 5A in a deploying state, according to an embodiment of the present disclosure.

FIG. 6A illustrates a perspective view of an exemplary warning device, according to an embodiment of the present disclosure.

FIG. 6B illustrates a perspective view of the exemplary warning device, according to an embodiment of the present disclosure.

FIG. 7 is a block diagram of a warning device deployment control system, according to an embodiment of the present disclosure.

FIG. 8 is a block diagram of the warning device deployment control system, according to an embodiment of the present disclosure.

FIG. 9 is a flow diagram of a method of automatically deploying warning devices for an autonomous vehicle, according to an embodiment of the present disclosure.

FIG. 10A illustrates a schematic view of another warning device deployment mechanism for a warning device deployment in a stored state, according to another embodiment of the present disclosure.

FIG. 10B illustrates a schematic view of the warning device deployment mechanism of FIG. 10A in a deploying state, according to an embodiment of the present disclosure.

### DETAILED DESCRIPTION

Various embodiments are discussed in detail below. While specific embodiments are discussed, this is done for illustration purposes only. A person skilled in the relevant art will recognize that other components and configurations may be used without departing from the spirit and scope of the present disclosure.

As used herein, the terms “first,” “second,” and “third” may be used interchangeably to distinguish one component from another and are not intended to signify location or importance of the individual components.

The terms “forward” and “rearward” refer to relative positions of a vehicle. For example, forward refers to a position closer to front hood, front bumper, or front fender of the vehicle and rearward refers to a position closer to a rear bumper, rear trunk, or trailer of the vehicle.

The terms “coupled,” “fixed,” “attached,” “connected,” and the like, refer to both direct coupling, fixing, attaching, or connecting as well as indirect coupling, fixing, attaching, or connecting through one or more intermediate components or features, unless otherwise specified herein.

The singular forms “a,” “an,” and “the” include plural references unless the context clearly dictates otherwise.

As used herein, “automated,” “autonomous,” or “automatic,” are used to describe functions that are done without user intervention (e.g., by a controller).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “relatively,” and “substantially” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a one, two, four, ten, fifteen, or twenty percent margin in either individual values, range(s) of values and/or endpoints defining range(s) of values.

When a vehicle stops on the road or the side of the road for various reasons, especially, when the stop may be unexpected, unplanned and/or not a necessary traffic stop (e.g., a routine stop at a traffic light or a stop sign), warning devices, such as warning triangles, flares, lights, or the like, may be required to be setup about the vehicle to notify other road users of the stopped vehicle for safety, for example, to prevent crashes and accidents. When a human operator gets out of the vehicle to setup the warning devices, the human operator may be in danger of being hit or stuck by another vehicle on the road. Further, when the vehicle is an autonomous vehicle (e.g., a vehicle that operates without a human in the vehicle), it is challenging to adequately warn or notify other road users of the stopped vehicle without a human present at the vehicle to deploy warning devices.

An autonomous vehicle is a vehicle that incorporates vehicular automation and that can sense the environment around the vehicle and can operate with little to no human input. Autonomous vehicles include various sensors to sense the environment. Control systems interpret the sensor information to identify navigation paths and to automatically control the autonomous vehicle. Autonomous vehicles include one or more sensors that gather data and information, communicate with the autonomous vehicle, and may assist in navigating the autonomous vehicle. The one or more sensors may include a plurality of redundant sensors (e.g., multiple sensors of the same type that measure the same type of data). One or more vehicle controllers receive the data and information from the one or more sensors to autonomously control and navigate the autonomous vehicle. For example, the one or more vehicle controllers automatically control one or more control systems (e.g., steering, power, throttle, brakes, etc.) of the autonomous vehicle to control the autonomous vehicle. In some instances, the autonomous vehicle may encounter an emergency such that the autonomous vehicle needs to stop. For example, the one or more vehicle controllers may detect a fault in the one or more sensors, in the one or more control systems, or in the vehicle controllers themselves, or a component on the vehicle may fail or otherwise become damaged. In such instances, the autonomous vehicle can initiate a fallback plan to stop the autonomous vehicle (e.g., either in the current traffic lane or on the shoulder of the road) or can initiate a failsafe plan to stop the autonomous vehicle in the current traffic lane, as detailed further below.

When the autonomous vehicle stops for an extended period of time (e.g., longer than ten minutes) for any reason other than a necessary traffic stop, warning devices (e.g., warning triangles, flares, lights, etc.) need to be placed on the road within a predetermined amount of time (e.g., ten minutes) to notify other road users of the stopped autonomous vehicle so as to prevent accidents. When the autonomous vehicle is operated by a human operator, such a requirement places the human operator at risk in placing the warning devices and the warning devices may fall over, and thus may be ineffective. Further, when the autonomous vehicle is operated without a human operator in the autonomous vehicle, there remains a need to deploy the warning devices without a human being present at the autonomous vehicle. Accordingly, the present disclosure provides systems and methods for automatically deploying warning devices for an autonomous vehicle.

Embodiments of the present disclosure provide for a warning device deployment system for automatically deploying warning devices for an autonomous vehicle. The warning device deployment system can store warning devices in a warning device deployment mechanism that is attached and mounted on a rear guardrail of the autonomous vehicle. The warning device deployment system can deploy the warning devices in the event of a fail-safe operation or another type of emergency of the autonomous vehicle. An emergency can be any type of system or vehicle fault or failure on the autonomous vehicle (e.g., faults in the sensors, the controllers, or the software of the autonomous vehicle, or damage or faults in the components of the vehicle, such as a blown tire, engine failure, or damage to other components of the vehicle). While reference is made to an emergency, the autonomous vehicle can stop and the warning devices can be deployed for any reason. The warning devices are dropped in a sequence as the autonomous vehicle stops such that the warning devices are evenly spaced behind the autonomous vehicle when deployed. The warning device deployment system deploys the warning devices so that the warning devices are visible to rear traffic.

Embodiments of the present disclosure provide for vehicle sensors or other components (e.g., software or hardware) of the autonomous vehicle that inform the vehicle controller of travel plans and health messages of the autonomous vehicle. The vehicle sensors or the other components of the autonomous vehicle can determine a health status (e.g., healthy or unhealthy) of the components of the autonomous vehicle. The health status may indicate whether the components of the autonomous vehicle are operating within predetermined parameters, whether the component is sensing within calibrated parameters, whether the component has any internal software faults, whether software and/or hardware is operating within predetermined parameters, etc. In this way, the vehicle sensors or the other components of the autonomous vehicle can inform the vehicle controller that one or more components of the autonomous vehicle are unhealthy or are otherwise not working properly such that the autonomous vehicle cannot safely operate autonomously.

The vehicle controller can send a fallback signal to initiate a fallback plan to navigate and to stop the autonomous vehicle (e.g., either in the current traffic lane or on the shoulder of the road) and to deploy the warning devices as the autonomous vehicle is stopping. For example, the vehicle controller can generate a fallback path and direct the autonomous vehicle on the fallback path to safely stop the autonomous vehicle. If the vehicle controller is unhealthy or otherwise not operating properly, a control monitor will send a fail-safe signal to stop the autonomous vehicle in the current traffic lane and deploy the warning devices as the autonomous vehicle is stopping. For example, the control monitor can generate a failsafe path to safely stop the autonomous in the current traffic lane. The vehicle controller or the control monitor can determine whether to initiate the fallback or the fail-safe based on whether the vehicle controller is unhealthy.

During an emergency, the autonomous vehicle automatically turns on the braking and hazard lights. If a shoulder is available during the fallback plan, the autonomous vehicle can pull over onto the shoulder. Otherwise, the autonomous vehicle stops in the traffic lane that the autonomous vehicle is currently in. The autonomous vehicle automatically deploys the warning devices as the autonomous vehicle is stopping.

The warning device deployment mechanism is connected and attached on the rear of the autonomous vehicle and is coupled to the vehicle controller via one or more signals. The vehicle controller provides communication and control signals to the warning device deployment mechanism to deploy the warning devices. The warning device deployment mechanism can include a singular component that stores multiple warning devices, or can include multiple components that each store a separate warning device. The warning device deployment mechanism is attached to the rear guardrail of the autonomous vehicle via straps, bolts, handles, brackets, welding, or the like. When the warning device deployment mechanism includes multiple mechanisms, each mechanism is connected to the vehicle controller to receive control signals. The warning device deployment is light weight (e.g., less than ten pounds).

The warning device deployment mechanism includes a case or storage container that houses a compressed warning device. For example, the warning device can be compressible and compressed when stored in the warning device deployment mechanism. A lid or a door closes the storage container when the warning device is stored inside, and the lid is locked by a release mechanism. The vehicle controller can control the release mechanism and/or the lid to open the lid. When the lid is opened, a spring pushes the warning device out of the storage container such that the warning device is deployed from the warning device deployment mechanism and drops to the ground. The warning device deployment mechanism can deploy the warning devices at various angles behind the autonomous vehicle (e.g., left, right, center). For example, when the autonomous vehicle is turning when stopping, the warning device deployment mechanism can deploy the warning devices to match the turn such that the warning devices are deployed on a predetermined side of the autonomous vehicle and/or on a predetermined side of the lane. The warning device deployment mechanism can store four warning devices for redundancy. For example, by regulation, the deployment mechanism can deploy three warning devices. A fourth warning device provides redundancy in instances where one of the three warning devices fails to deploy.

The warning devices can include a self-expanding warning device. As used herein, a self-expanding warning device includes a device that expands from an unexpanded or compressed shape to an expanded shape without human intervention at the device. For example, the warning devices can be made from memory foam or like material such that the warning devices are compressible and can be compressed when stored in the warning device deployment mechanism. The memory foam allows the warning devices to expand when deployed from the deployment mechanism and allows the warning devices to self-right and stand up on the road without human intervention. In some examples, the warning devices include hinges or springs such that expand the warning device to the expanded shape.

In some examples, the warning devices include warning triangles. The warning triangles can include a tetrahedron shape. The tetrahedron shape of the warning devices allows the warning devices to display one or multiple warning faces and ensures that at least one face is visible to other drivers or operators when the warning devices are deployed. The warning faces can include a reflective material. The reflective material can be manufactured as part of the memory foam material, can include a reflective tape applied to the warning device, and/or can include a reflective paint applied to the warning device.

The self-expandable property (e.g., memory foam, hinges, or the like) of the warning devices allows the warning device to compact to a smaller volume such that the warning device can be stored in the deployment mechanism in a flat or otherwise reduced volume. The memory foam allows for an anti-rolling design such that the warning device does not roll when deployed from the deployment mechanism. The memory foam also allows the warning device to be self-inflating or otherwise self-expanding such that the warning device inflates or otherwise expands to a deployed state when deployed onto the road. The memory foam also allows for increased density when the warning device is dropped onto the road such that the warning device does not blow or otherwise move away from the location at which the warning device is dropped. In some examples, the warning device includes one or more weights in a base portion thereof. The weights assist in preventing the warning device from moving from the deployment location when the warning device is dropped onto the road. Thus, the embodiments of the present disclosure provide for an improved warning device deployment system and an improved warning device.

The embodiments of the present disclosure provide for a warning device deployment system and warning devices that do not require a human to be deployed or otherwise setup. In this way, a human does not need to exit their vehicle to deploy the warning devices and/or a human does not need to be present at the autonomous vehicle to deploy the warning devices. Accordingly, the systems and methods of the present disclosure allow the warning devices to be deployed without the need of a human to physically deploy the warning devices.

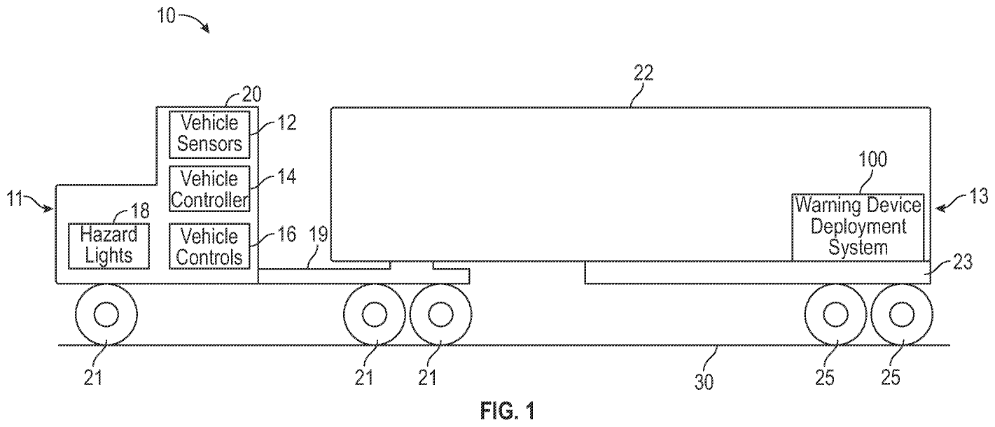

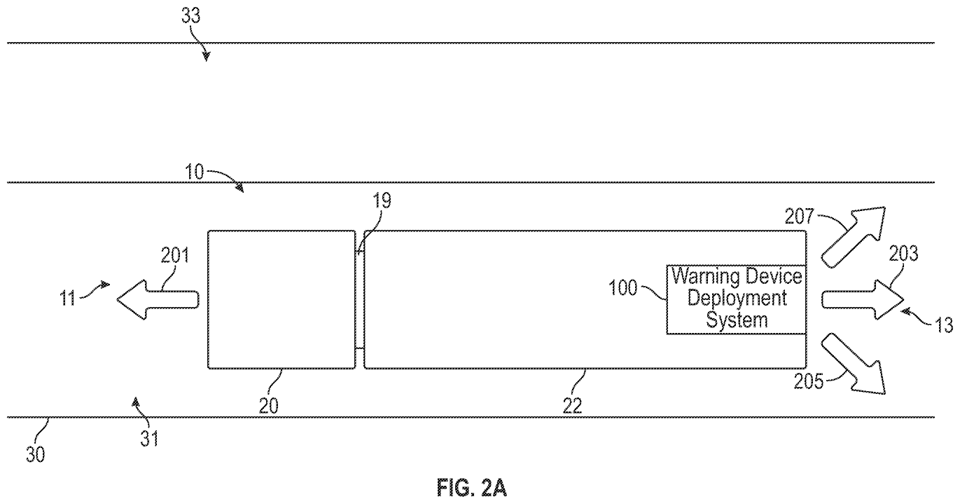

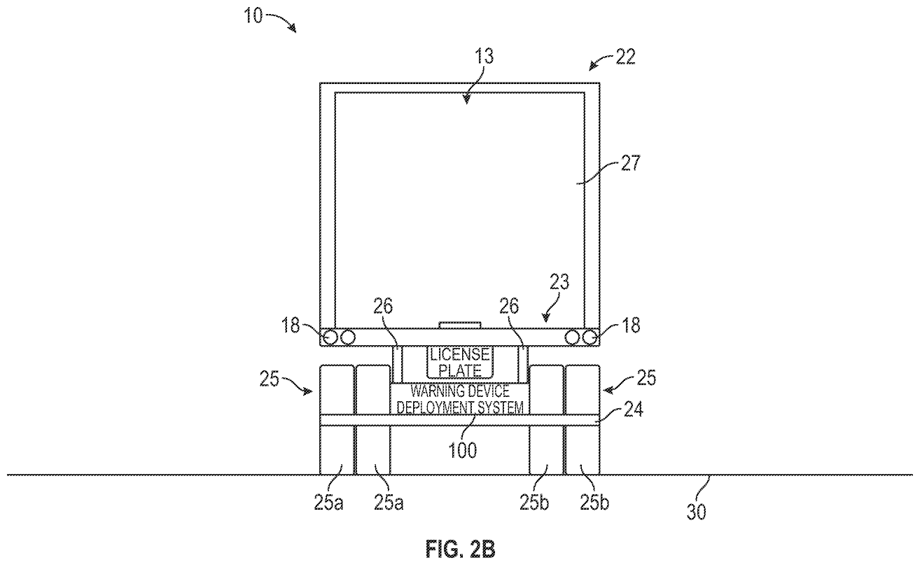

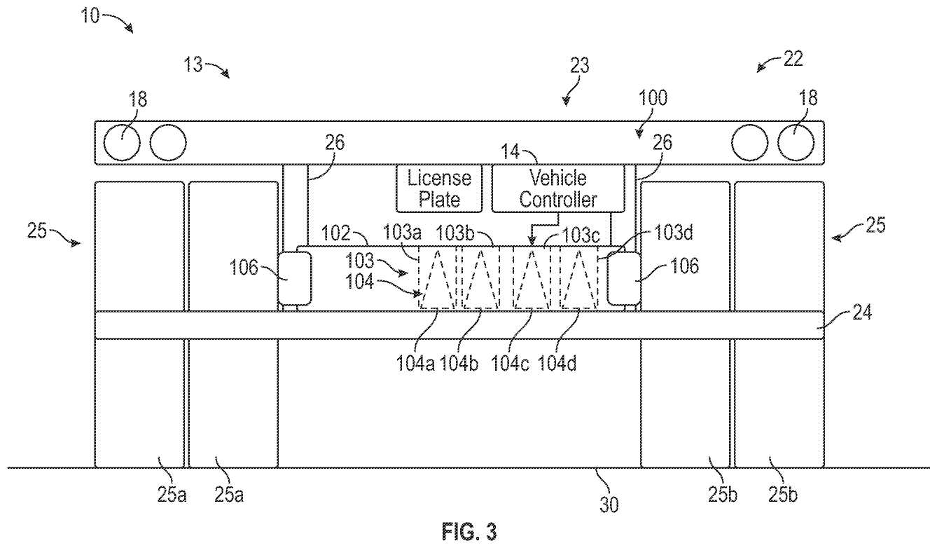

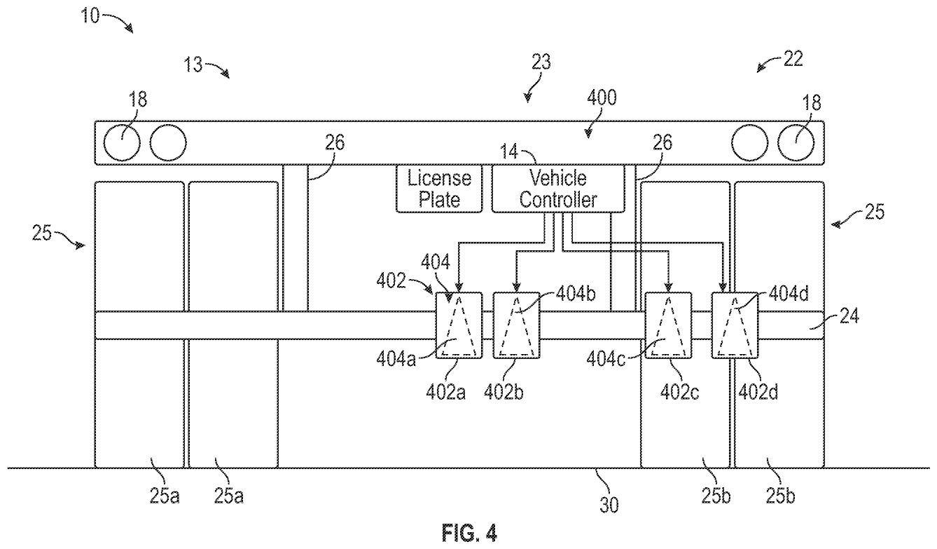

Referring to the drawings, FIGS. 1 and 2A-2B illustrate a side view, a top view, and a rear view, respectively, of an autonomous vehicle 10 with a warning device deployment system 100 according to embodiments of the present disclosure. FIG. 3 illustrates one embodiment of the warning device deployment system 100 and FIG. 4 illustrates another embodiment of a warning device deployment system 400, according to embodiments of the present disclosure, as discussed in more detail below. FIGS. 1 and 2A-2B show the warning device deployment system 100 is represented schematically by a box and show a general location of the warning device deployment system 100. FIGS. 3 and 4 show components and representative locations of the warning device deployment system 100 and the warning device deployment system 400, respectively.

FIG. 1 illustrates a schematic, side view of an autonomous vehicle 10 including a warning device deployment system 100, according to an embodiment of the present disclosure. The autonomous vehicle 10 may be any motor vehicle, such as, for example, but not limited to a car, a truck, a commercial truck, a bus, a watercraft (e.g., boat, ship, underwater vehicles, etc.), a motorcycle, an aircraft (e.g., airplane, helicopter, etc.), or any other type of vehicle. For ease of description, the autonomous vehicle 10 may be referred to herein as a truck. Further, while reference is made to an autonomous vehicle herein, the embodiments of the present disclosure may be used in semi-autonomous vehicles (e.g., vehicles with some human input) and may be used in vehicles that are operated manually by a human operator in the vehicle or remote from the vehicle and have some aspects controlled autonomously (e.g., such as the warning device deployment system 100). The autonomous vehicle may have a forward end 11, also referred to as a forward side, a front side, or a front end, and a rear end 13, also referred to as a rear side, rearward end, or rearward side. The autonomous vehicle 10 includes one or more vehicle sensors 12, a vehicle controller 14, vehicle controls 16, and hazard lights 18. When the autonomous vehicle 10 is a truck, the autonomous vehicle 10 includes a tractor unit 20 that is configured to support and tow a trailer 22, such as a semitrailer. The tractor unit 20 includes a tractor unit frame 19 for supporting the trailer 22 when the trailer 22 is coupled to the tractor unit 20. The tractor unit 20 includes tractor unit wheels 21 that enable the tractor unit 20 to maneuver about a road 30 or other ground surface. The trailer 22 includes a trailer frame 23 and trailer wheels 25. The hazard lights 18 can include any type of hazard light located anywhere on the autonomous vehicle 10. For example, the hazard lights 18 are intermittent flashing indicator lights that flash in unison. The hazard lights 18 are used to indicate an emergency of the autonomous vehicle 10 to other vehicle operators or road users.

The vehicle sensors 12 may assist in navigation of the autonomous vehicle 10. In some examples, the vehicle sensors 12 may assist in navigation in a manner that results in the autonomous vehicle 10 being autonomous, self-driving, semi-autonomous, non-autonomous with assisted navigation, etc., or combinations thereof. In this regard, the vehicle sensors 12 may include components, such as, but not limited to, sensors or other devices, that may be useful for the operation of the vehicle, or any combination thereof. The autonomous vehicle 10 may use (via the vehicle controller 14) data collected by the vehicle sensors 12 to navigate or to assist in navigating the autonomous vehicle 10 along the road 30 and to control the vehicle controls 16 to control the speed, the direction, the braking, and other functions of the autonomous vehicle 10. By way of example, the vehicle sensors 12 may be, or may include the sensors, cameras, and mirrors, described in U.S. Patent Application Publication No. US2022/0144185, the contents of which are herein incorporated by reference in their entirety. The vehicle sensors 12 may take any form and may be located and mounted at any location on the autonomous vehicle 10, as desired.

The vehicle sensors 12 include a variety of sensors to monitor the surroundings of the autonomous vehicle 10. The sensors may include, for example, but not limited to, one or more cameras, one or more lidars, one or more radars, one or more global positioning systems (GPS), and one or more inertial measurement units (IMUs). The combined data from the sensors may be used by a processor (e.g., the vehicle controller 14) to autonomously (or semi-autonomously) navigate or to assist a driver in navigating the roadway in a variety of light conditions, weather conditions, traffic conditions, load conditions, road conditions, etc. The sensors and the other features of the vehicle sensors 12 are configured and oriented to provide a predetermined field of view and to provide reliable, accurate, and high-quality data for autonomous and semi-autonomous driving. The cameras may include a plurality of cameras including one or more cameras facing the forward end 11, one or more cameras facing the rear end 13, and one or more cameras facing a lateral side perpendicular to the forward end and rear end. In some examples, the cameras may include narrow field of view camera(s), thermal camera(s), wide field of view camera(s), side-facing camera(s), and/or e-mirror camera(s). The aforementioned cameras are merely exemplary, and any number or type of cameras may be included to facilitate the autonomous, semi-autonomous, or assisted navigation of the autonomous vehicle 10, including, the cameras described in U.S. Patent Application Publication No. US2022/0144185.

The lidars, the radars, the GPS, the IMUs, and the cameras all provide information and data to autonomously or semi-autonomously operate and navigate the autonomous vehicle 10 and/or provide information and data to assist in the navigation of the autonomous vehicle 10 where an operator is present inside the cab of the autonomous vehicle 10. For example, the lidars may assist in tracking vehicles or objects passing or being passed by the autonomous vehicle. In an example, the radars may enable the autonomous vehicle to navigate in difficult weather and light conditions. The radars may supplement the information from the cameras and from the lidars, which may have difficulty obtaining clear images and signals in the presence of certain weather conditions, such as fog, rain, and snow. The radars may also provide information regarding objects that are occluded in the camera date and the lidar data. In an example, the cameras may track vehicles or objects and assist in tracking of the vehicles or of the objects. The GPS can provide a geolocation of the autonomous vehicle 10 and can communicate with other GPS systems to provide geolocations of other vehicles around the autonomous vehicle 10. Thus, the vehicle sensors 12 can sense an environment of the autonomous vehicle 10 including, for example, objects around the autonomous vehicle 10, a road on which the autonomous vehicle 10 is operating, curvature of the road, slope of the road, weather conditions, light conditions, and other information regarding the environment about the autonomous vehicle 10.

The vehicle controller 14 is in two-way communication with the vehicle sensors 12, the vehicle controls 14, and the hazard lights 18. In this way, the vehicle controller 14 sends and/or receives the data from the vehicle sensors 12 and controls the vehicle controls 16 and/or the hazard lights 18. The vehicle controls 16 include systems for controlling operation of the autonomous vehicle 10 to autonomously or semi-autonomously control the autonomous vehicle 10. The systems include, for example, an engine, a steering system, a braking system, and other systems that control operation of the autonomous vehicle 10. The engine may include any type of engine, for example, an internal combustion engine, an electric motor, a hybrid-electric engine, or other types of power units for propelling, for moving, or for powering the autonomous vehicle 10. The vehicle controls 16 include actuators or other devices that control fuel flow, acceleration (e.g., a throttle), steering, braking, or other vehicle controls of the autonomous vehicle 10. Thus, the vehicle controller 14 controls the vehicle controls 16 to propel, move, steer, accelerate, and stop the autonomous vehicle 10, as detailed further below.

During operation, the autonomous vehicle 10 drives or otherwise operates on a road 30 or other driving surface. When the autonomous vehicle 10 encounters an emergency, the warning device deployment system 100 can deploy or otherwise deploy one or more warning devices during the emergency of the autonomous vehicle 10, as detailed further below. The warning device deployment system 100 is located at the rear end 13 of the autonomous vehicle 10. The warning device deployment system 100, however, can be located anywhere on the autonomous vehicle 10, as desired.

FIG. 2A illustrates a schematic, top plan view of the autonomous vehicle 10 including the warning device deployment system 100, according to an embodiment of the present disclosure. FIG. 2A shows the autonomous vehicle 10 can drive in a driving direction 201 in a traffic lane 31 of the road 30. The road 30 can include any number of traffic lanes. In some examples, the road 30 includes a shoulder 33. The shoulder 33 is an emergency stopping lane that is immediately adjacent to the traffic lane 31 and includes a strip of pavement outside of the traffic lane 31. The shoulder 33 can be on the right side of the traffic lane 31, the left side of the traffic lane 31, or on both the right side and the left side of the traffic lane 31. When the autonomous vehicle 10 is in an emergency, the autonomous vehicle 10 can automatically stop and control the warning device deployment system 100 to deploy one or more warning devices while the autonomous vehicle 10 is stopping. For example, the autonomous vehicle 10 can stop in the traffic lane 31 and deploy the warning devices behind the autonomous vehicle 10 in the traffic lane 31 while the autonomous vehicle 10 is stopping. When the road 30 includes a shoulder 33, the autonomous vehicle 10 can pull onto the shoulder 33 (e.g., steer onto the shoulder 33) while stopping and deploy the warning devices on the shoulder 33. The warning device deployment system 100 can deploy the warning devices in any direction from the autonomous vehicle 10. For example, the warning device deployment system 100 can deploy the warning devices at a center 203 behind the autonomous vehicle 10, to the left 205, to the right 207, or combinations thereof. While a traffic lane 31 and a shoulder 33 are detailed herein, the autonomous vehicle 10 can stop anywhere in the road 30 or immediately adjacent to the road 30, as necessary.

FIG. 2B illustrates a schematic, rear end 13 view of the autonomous vehicle 10 including the warning device deployment system 100, according to an embodiment of the present disclosure. FIG. 2B shows the trailer 22 includes a first set of trailer wheels 25a and a second set of trailer wheels 25b. When viewing the rear end 13, the first set of trailer wheels 25a are on a left side thereof and the second set of trailer wheels 25b are on a right side thereof. The trailer 22 includes one or more trailer doors 27 for providing access to an interior of the trailer 22.

The trailer frame 23 includes a horizontal rear guardrail 24 that is supported by one or more vertical rear guardrails 26 and located at the rear end 13 of the trailer 22. The horizontal rear guardrail 24 helps to prevent other vehicles from sliding or otherwise moving underneath the trailer 22. The horizontal rear guardrail 24 and/or the vertical rear guardrails 26 can include one or more reflective surfaces (e.g., such as reflective tape or reflective paint) applied thereto to reflect light and notify other road users of the autonomous vehicle 10. The warning device deployment system 100 can be coupled to the horizontal rear guardrail and/or to the vertical rear guardrails 26, as detailed further below.

FIG. 3 illustrates a schematic, rear end 13 view of the autonomous vehicle 10 including a detailed view of the warning device deployment system 100, according to an embodiment of the present disclosure. In FIG. 3, a portion of the trailer 22 has been removed for clarity and only the trailer frame 23, trailer wheels 25, and the warning device deployment system 100 are shown. The warning device deployment system 100 includes a warning device deployment mechanism 102 that stores one or more warning devices 104. The warning devices 104 are shown by dashed lines in FIG. 3 as the warning devices 104 are disposed inside the warning device deployment mechanism 102. In the exemplary embodiment, the warning devices 104 include safety triangles. The warning devices 104, however, may include any type of warning device, such as, for example, flares, cones, lights, or the like. The warning devices 104 are stowed in the warning device deployment mechanism 102 when the warning device deployment system 100 is not in use (as shown in FIG. 3). The warning devices 104 can be compacted when stowed in the warning device deployment mechanism 102. For example, the warning devices 104 can be made from a material that compacts or retracts when the warning devices 104 are stowed in the warning device deployment mechanism 102 and that expands when the warning devices 104 are deployed from the warning device deployment mechanism 102, as detailed further below.

The warning device deployment mechanism 102 is attached to the rear end 13 of the autonomous vehicle 10. In FIG. 3, the warning device deployment mechanism 102 is mounted on the horizontal rear guardrail 24 of the trailer 22. The warning device deployment mechanism 102 includes one or more attachment devices 106 for securing and attaching the warning device deployment mechanism 102 to the one or more vertical rear guardrails 26 of the trailer 22. The attachment devices 106 can include handles, straps, brackets, bolts, welding, or the like, for attaching to the vertical rear guardrails 26. The warning device deployment mechanism 102 can be attached to the rear guardrails 24, 26 so as not to interfere or otherwise cover reflective surfaces of the rear guardrails 24, 26. The warning device deployment mechanism 102 can be attached to the autonomous vehicle 10 at any location and by any attachment means as desired.

When attached to the autonomous vehicle 10, the warning device deployment mechanism 102 can be located forward of the rear end of the rear guardrails 24, 26 such that the warning device deployment mechanism 102 does not extend rearward of the rear guardrails 24, 26. In this way, the warning device deployment mechanism 102 does not increase the length of the autonomous vehicle 10 and does not otherwise stick out from the rear end 13 of the autonomous vehicle 10. The warning device deployment mechanism 102 includes a length such that a portion of the warning device deployment mechanism 102 hangs over the horizontal rear guardrail 24 in a forward direction of the horizontal rear guardrail 24. In this way, the warning devices 104 can be deployed from a bottom of the warning device deployment mechanism 102, as detailed further below. The warning device deployment mechanism 102 includes a width such that the warning device deployment mechanism 102 extends between the vertical rear guardrails 26. The warning device deployment mechanism 102 includes a height for storing the warning devices 104. The warning device deployment mechanism 102 may include any length, width, or height, as desired, for storing and deploying the warning devices 104 and for being attached and secured to the autonomous vehicle 10.

The warning device deployment mechanism 102 includes one or more storage containers 103 for storing the warning devices 104 therein. The storage containers 103 are disposed inside the warning device deployment mechanism 102 and provide a compartment in which the warning devices 104 can be inserted and stored. In FIG. 3, the storage containers 103 include four storage containers, including, a first storage container 103a, a second storage container 103b, a third storage container 103c, and a fourth storage container 103d. In some examples, the warning device deployment mechanism 102 includes a single, large storage container 103 for storing the warning devices 104 therein. The warning device deployment mechanism 102 can include more than four storage containers 103, fewer than four storage containers 103, or any number of storage containers 103, as desired, for storing corresponding warning devices 104.

The warning devices 104 include four warning devices including a first warning device 104a, a second warning device 104b, a third warning device 104c, and a fourth warning device 104d. For example, the first warning device 104a is stored in the first storage container 103a, the second warning device 104b is stored in the second storage container 103b, the third warning device 104c is stored in the third storage container 103c, and the fourth warning device 104d is stored in the fourth storage container 103d. The warning devices 104 can include more than four warning devices 104, fewer than four warning devices 104, or any number of warning devices 104, as desired.

The vehicle controller 14 is in two-way communication with the warning device deployment mechanism 102. The vehicle controller 14 sends control signals to the warning device deployment mechanism 102 to control the warning device deployment mechanism 102 to deploy the warning devices 104 and can receive signals from the warning device deployment mechanism 102 indicating a status of the warning device deployment mechanism 102 (e.g., opened or closed). The vehicle controller 14 can deploy the warning devices 104 in a sequence to deploy the warning devices 104 at predetermined distances from the autonomous vehicle 10 based on a stopping distance of the autonomous vehicle 10, as detailed further below. For example, the warning device deployment mechanism 102 can deploy the first warning device 104a at a first distance from the autonomous vehicle 10, the second warning device 104b at a second distance from the autonomous vehicle 10, and the third warning device 104c at a third distance from the autonomous vehicle 10. The fourth warning device 104d can be used as a backup if one of the warning devices 104 does not deploy, or can also be deployed in addition to the first warning device 104a, the second warning device 104b, and the third warning device 104c.

The warning devices 104 can be stored or positioned within the warning device deployment mechanism 102 such that the autonomous vehicle 10 can deploy the warning devices 104 based on a stopping maneuver of the autonomous vehicle 10 and/or based on a traffic lane that the autonomous vehicle is stopping in. For example, if the autonomous vehicle 10 is turning left, the autonomous vehicle 10 can deploy a rightmost warning device 104 (e.g., the first warning device 104a) first to ensure the warning devices 104 are deployed on a correct side of the autonomous vehicle 10 when the autonomous vehicle 10 is stopped. If the autonomous vehicle 10 is in a right lane or on a right shoulder of the road, the autonomous vehicle 10 can deploy the warning devices 104 to a left side of the autonomous vehicle 10.

The warning device deployment mechanism 102 can include a single storage container 103 or compartment for storing the warning devices 104 inside the warning device deployment mechanism 102. The warning devices 104 can be deployed through separate doors of the warning device deployment mechanism 102, as detailed further below. In some examples, the warning device deployment mechanism 102 can be separated into separate storage containers 103 or compartments for storing the separate warning devices 104, as detailed above. In some examples, the warning device deployment mechanism 102 can include a single door such that all of the warning devices 104 are deployed from the warning device deployment mechanism 102 through the single door.

FIG. 4 illustrates a schematic, rear end 13 view of the autonomous vehicle 10 including a detailed view of a warning device deployment system 400, according to another embodiment of the present disclosure. In FIG. 4, a portion of the trailer 22 has been removed for clarity and only the trailer frame 23, the trailer wheels 25, and the warning device deployment system 400 is shown. The warning device deployment system 400 includes one or more warning device deployment mechanisms 402 that store one or more warning devices 404. The warning devices 404 are shown by dashed lines in FIG. 4 as the warning devices 404 are disposed inside the warning device deployment mechanisms 402. The warning device deployment system 400 includes a plurality of warning device deployment mechanisms 402. The warning devices 404 are stowed in the warning device deployment mechanisms 402 when the warning device deployment system 400 is not in use (as shown in FIG. 4). The warning devices 404 can be compacted when stowed in the warning device deployment mechanisms 402, as detailed further below.

The warning device deployment mechanisms 402 are attached to the rear end 13 of the autonomous vehicle 10. In FIG. 4, the warning device deployment mechanisms 402 are mounted and attached on the horizontal rear guardrail 24 of the trailer 22. The warning device deployment mechanisms 402 can include handles, straps, bolts, or the like, for attaching to the horizontal rear guardrails 24, as detailed further below. The warning device deployment mechanisms 402 can be attached to the horizontal rear guardrails 24 so as not to interfere or otherwise cover reflective surfaces of the rear guardrails 24, 26. The warning device deployment mechanisms 402 can be attached to the autonomous vehicle 10 at any location and by any attachment means as desired.

When attached to the autonomous vehicle 10, the warning device deployment mechanisms 402 can be located forward of the rear end of the horizontal rear guardrail 24 such that the warning device deployment mechanisms 402 do not extend rearward of the horizontal rear guardrail 24. In this way, the warning device deployment mechanisms 402 do not increase the length of the autonomous vehicle 10 and do not otherwise stick out from the rear end 13 of the autonomous vehicle 10. The warning device deployment mechanisms 402 include a length such that a portion of the warning device deployment mechanisms 402 hangs over the horizontal rear guardrail 24 in a forward direction of the horizontal rear guardrail 24. In this way, the warning devices 404 can be deployed from a bottom of the warning device deployment mechanisms 402, as detailed further below. The warning device deployment mechanisms 402 include a width and a height such that the warning devices 404 are compacted when stored in the warning device deployment mechanisms 402 and expand when deployed from the warning device deployment mechanisms 402. The warning device deployment mechanisms 402 may include any length, width, or height, as desired, for storing and deploying the warning devices 404 and for being attached and secured to the autonomous vehicle 10.

In FIG. 4, the warning device deployment mechanisms 402 include four warning device deployment mechanisms 402 including a first warning device deployment mechanism 402a, a second warning device deployment mechanism 402b, a third warning device deployment mechanism 402c, and a fourth warning device deployment mechanism 402d. Each warning device deployment mechanism 402 provides a separate storage container for a respective warning device 404. The warning device deployment mechanisms 402 can include more than four warning device deployment mechanisms 402, fewer than four warning device deployment mechanisms 402, or any number of warning device deployment mechanisms 402, as desired, for storing corresponding warning devices 404.

The warning devices 404 include four warning devices including a first warning device 404a stored in the first warning device deployment mechanism 402a, a second warning device 404b stored in the second warning device deployment mechanism 402b, a third warning device 404c stored in the third warning device deployment mechanism 402c, and a fourth warning device 104d stored in the fourth warning device deployment mechanism 402d. The warning devices 404 can include more than four warning devices 404, fewer than four warning devices 404, or any number of warning devices 404, as desired.

The vehicle controller 14 is in two-way communication with each of the warning device deployment mechanisms 402. The vehicle controller 14 sends control signals to each of the warning device deployment mechanisms 402 to control the warning device deployment mechanisms 402 to deploy the warning devices 404 and can receive signals from the warning device deployment mechanisms 402 indicating a status of the warning device deployment mechanisms 402 (e.g., opened or closed. The vehicle controller 14 can deploy the warning devices 404 in a sequence to deploy the warning devices 404 at predetermined distances from the autonomous vehicle 10 based on a stopping distance of the autonomous vehicle 10, as detailed further below. For example, the first warning device deployment mechanism 402a can deploy the first warning device 404a at a first distance from the autonomous vehicle 10, the second warning device deployment mechanism 402b can deploy second warning device 404b at a second distance from the autonomous vehicle 10, and the third warning device deployment mechanism 402c can deploy the third warning device 404c at a third distance from the autonomous vehicle 10. The fourth warning device deployment mechanism 402d can be used as a backup to deploy the fourth warning device 404d if one of the warning devices 404 does not deploy, or can also deploy the fourth warning device 404d in addition to the first warning device 404a, the second warning device 404b, and the third warning device 404c.

The warning device deployment mechanisms 402 each include a single compartment for storing the respective warning devices 404 inside the respective warning device deployment mechanism 402. Each warning device deployment mechanism 402 includes a door or a latch for deploying the respective warning device 404 from the warning device deployment mechanisms 402, as detailed further below.

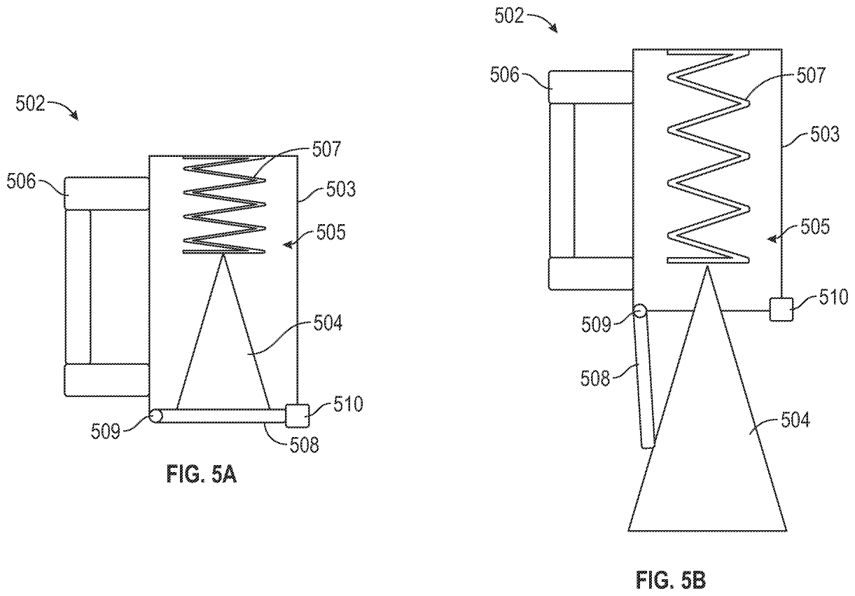

FIG. 5A illustrates a schematic view of a warning device deployment mechanism 502 for a warning device deployment system in a stored state, according to an embodiment of the present disclosure. The warning device deployment mechanism 502 can be used for any of the warning device deployment systems detailed herein. The warning device deployment mechanism 502 includes a storage container 503 that includes an attachment device 506 for attaching the warning device deployment mechanism 502 to the autonomous vehicle 10 (FIGS. 1 to 4). In FIGS. 5A and 5B, a portion of the storage container 503 is removed such that the interior 505 is shown. In FIG. 5A, the attachment device 506 includes a strap for attaching and securing the deployment mechanism to the autonomous vehicle 10. The attachment device 506 may include any type of attachment device, including, for example, handles, brackets, bolts, welding, or the like. Further, while only one attachment device 506 is shown in FIGS. 5A and 5B, the warning device deployment mechanism 502 can include any number of attachment devices 506.

The storage container 503 is a hollow container having an interior 505 for storing a warning device 504 therein. The interior 505 of the storage container 503 includes a biasing member 507. As used herein, a “biasing member” includes a resilient, rigid, semi-rigid, flexible, or elastic member, and may be formed of any material, such as, for example, metals, polymers, plastics, elastomers, composite materials, rubber, or the like. The resilient nature of the biasing member enables the biasing member to move from a biased state to a non-biased state. In FIG. 5A, the biasing member 507 is a tension spring such that the biased state is when the biasing member is compressed, and the non-biased state is when the biasing member is extended or otherwise expands.

The storage container 503 includes a door 508 on a bottom side thereof. The door 508 is attached to the storage container 503 at a hinge 509. The hinge 509 allows the door 508 to pivot from a close position (FIG. 5A) to an open position (FIG. 5B), and therebetween. The hinge 509 can be a power hinge such that the hinge 509 is controlled by the vehicle controller 14 (FIGS. 1 to 4) to open and to close the door 508. When closed, the door 508 is locked by a locking mechanism 510. The locking mechanism 510 can include a bolt that can be actuated to be retracted to unlock the locking mechanism 510 and to be extended to lock the locking mechanism 510. Thus, the door 508 seals the warning device deployment mechanism 502 when the door 508 is closed such that the door 508 helps to protect the warning device 504 from road grime, dirt, mud, weather (e.g., rain), etc. When the warning device 504 is stored in the warning device deployment mechanism 502, the warning device 504 compresses the biasing member 507 to the biased state. In this way, the biasing member 507 stores mechanical energy when the warning device 504 is disposed within the storage container 503 and the door 508 is closed. The warning device 504 can also be compressed when stored in the warning device deployment mechanism 502. When the autonomous vehicle 10 encounters an emergency, the autonomous vehicle 10 can deploy the warning device 504, as detailed further below.

FIG. 5B illustrates a schematic view of the warning device deployment mechanism 502 in a deploying state, according to an embodiment of the present disclosure. To deploy the warning device 504, the vehicle controller 14 controls the locking mechanism 510 to unlock and the door 508 pivots about the hinge 509 and swings open. When the door 508 opens, the biasing member 507 extends and releases the stored mechanical energy. In this way, the biasing member 507 ejects or otherwise deploys the warning device 504 from the interior 505 of the storage container 503. The warning device 504 expands to an original shape when deployed from the warning device deployment mechanism 502. Thus, the warning device 504 can be deployed when the autonomous vehicle 10 (FIGS. 1 to 4) encounters an emergency or for any other reason as needed. When the emergency is over or the warning device 504 is no longer needed to be deployed, a human operator can manually pick up the warning device 504 and insert the warning device 504 back into the warning device deployment mechanism 502. In this way, the warning device 504 is compressed into the storage container 503, thereby compressing the biasing member 507. The door 508 can be closed automatically or can be manually closed by the human operator to close the storage container 503.

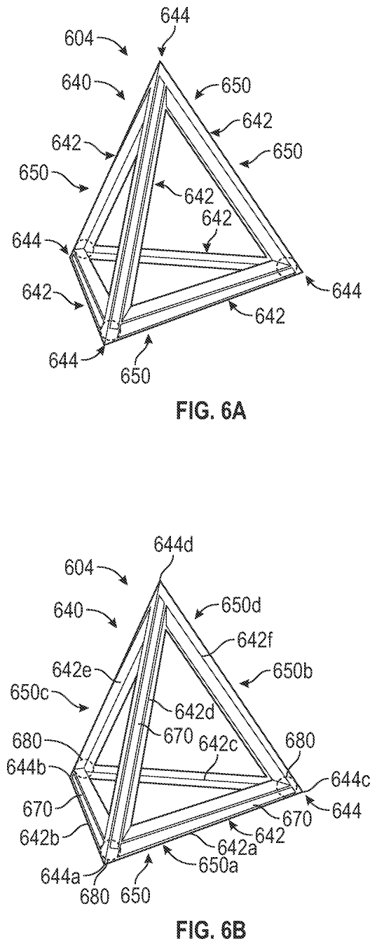

FIGS. 6A and 6B illustrate perspective views of an exemplary warning device 604, according to an embodiment of the present disclosure. The warning device 604 can be used in any of the warning device deployment systems detailed herein. The warning device 604 defines a tetrahedron fame 640, also referred to as a triangular pyramid, that includes six edges, four vertices, and four triangular faces. As shown in FIG. 6A, the warning device 604 includes a plurality of edges 642 connected at a plurality of vertices 644 and the plurality of edges 642 define a plurality of triangular faces 650. The warning device 604 includes six edges 642, four vertices 644, and four triangular faces 650. The edges 642 include straight edges, the vertices 644 define corners of the warning device 604, and the triangular faces 650 define sides of the warning device 604. In some embodiments, the edges 642 can include curved or other non-straight edges.

As shown in FIG. 6B, the plurality of edges 642 include a first edge 642a, a second edge 642b, a third edge 642c, a fourth edge 642d, a fifth edge 642e, and a sixth edge 642f. The plurality of vertices 644 include a first vertex 644a, a second vertex 644b, a third vertex 644c, and a fourth vertex 644d. The plurality of triangular faces 650 include a first triangular face (also referred to as a base 650a), a second triangular face 650b, a third triangular face 650c, and a fourth triangular face 650d.

The first edge 642a is connected to the second edge 642b at the first vertex 644a, the second edge 642b is connected to the third edge 642c at the second vertex 644b, and the third edge 642c is connected to the first edge 642a at the third vertex 644c. In this way, the first edge 642a, the second edge 642b, and the third edge 642c together define the base 650a (the first triangular face). The fourth edge 642d is connected to the first edge 642a and the second edge 642b at the first vertex 644a. The fifth edge 642e is connected to the second edge 642b and the third edge 642c at the second vertex 644b. The sixth edge 642f is connected to the third edge 642c and the first edge 642a at the third vertex 644c. The fourth edge 642d, the fifth edge 642e, and the sixth edge 642f are connected at the fourth vertex 644d. The first edge 642a, the fourth edge 642d, and the sixth edge 642f together define the second triangular face 650b. The second edge 642b, the fourth edge 642d, and the fifth edge 642e together define the third triangular face 650c. The third edge 642c, the fifth edge 642e, and the sixth edge 642f together define the fourth triangular face 650d. Accordingly, the warning device 604 includes six edges 642, four vertices 644, and four triangular faces 650. Each edge 642 includes a length and a width when the warning device 604 is in an expanded state. For example, the length of each edge 642 is between seventeen inches and twenty-two inches, and the width of each edge 642 is between two inches and three inches. In this way, the warning device 604 includes dimensions that are in compliance with regulations.

The warning device 604 is self-expandable such that the warning device 604 can be compacted or otherwise deformed when the warning device 604 is stored in a warning device deployment system. The warning device 604 can expand or otherwise return to an original, expanded shape when the warning device 604 is deployed from the warning device deployment system onto the road. FIG. 6 shows the original, expanded shape of the warning device 604. In some examples, the warning device 604 is made from a viscoelastic material such that the warning device 604 is self-expandable (e.g., can compact and deform when stored in the warning device deployment system and expand to the expanded shape when the warning device 604 is deployed from the warning device deployment system). As used herein, a “viscoelastic” material is a material that exhibits both elastic and viscous characteristics when deformed. Viscoelastic materials exhibit mechanical properties intermediate between viscous materials and elastic materials. The warning device is made from, for example, memory foam (e.g., polyurethane) or other types of polymers, plastics, or the like, that can compact and return to an original shape. The viscoelastic material of the warning device (e.g., memory foam or the like) allows the warning device to return to the original, expanded, shape of the warning device when force is removed. In one embodiment, the warning device can be made of any material that returns relatively slowly (e.g., in 5 to 10 seconds) to an original shape of the warning device when force removed.

The material of the warning device 604 can include a reflective material (e.g., aluminum, fluorescent, glass reflective beads, etc.) such that the warning device 604 reflects light and increase visibility in low light conditions. In some examples, a reflective tape 670 is applied to an outer surface of the warning device 604 to provide the increased visibility in low light conditions. For example, the reflective tape 670 can be applied to the outer surfaces of the edges 642. In some examples, the reflective material can include a reflective paint applied to the warning device 604.

The warning device 604 is weighted such that the warning device 604 stands upright in the expanded shape when the warning device 604 is deployed onto the road. For example, the material of the warning device 604 can be chosen such that the density of the material allows the warning device 604 to be compressed and expanded, while also allowing the warning device 604 to stand upright without tipping over or moving when the warning device 604 is deployed onto the road. In some examples, the base 650a can include one or more weights 680 disposed therein. For example, the weights 680 can include bags of plastic pellets or the like to provide additional weight to the base 650a. In this way, the base 650a ensures stability of the warning device 604 when the warning device 604 is deployed onto the road and ensures that the warning device 604 stands upright without tipping over. In FIG. 6, the weights 680 are located at the vertices of the base 650a (e.g., the first vertex 644a, the second vertex 644b, and the third vertex 644c). In some examples, the base 650a can include plastic pellets or other weighted material disposed throughout the interior of the edges of the base 650a (e.g., disposed inside the first edge 642a, the second edge 642b, and/or the third edge 642c). The additional weight of the base 650a can also be provided by a separate weighted apparatus attached to the base 650a. The warning device 604 is weighted such that the warning device 604 does not move when the warning device 604 is deployed. For example, the warning device 604 may be weighted such that the warning device 604 does not move than three inches from its initial position in horizontal winds of forty miles per hour in any direction for three minutes. Further, the tetrahedron shape helps to ensure that the triangular faces of the warning device 604 do not tilt to a position that is more than ten degrees from the vertical and not more than ten degrees from a horizontal direction.

In some examples, rather than, or in addition to, the materials of the warning device 604 providing the self-expandable property of the warning device 604, the warning device 604 can include one or more hinges or joints with biasing members or like devices such that the warning device 604 is self-expandable. For example, the hinges or joints can be located at the vertices 644 such that one or more of the edges 642 can fold down or fold up to compress or expand the warning device 604, respectively. In some examples, the warning device 604 can include one or more electrically powered actuators that compress and expand the warning device 604. The one or more actuators can be battery powered and can be controlled, for example, by the vehicle controller 14 or by a remote operator to compress or expand the warning device 604.

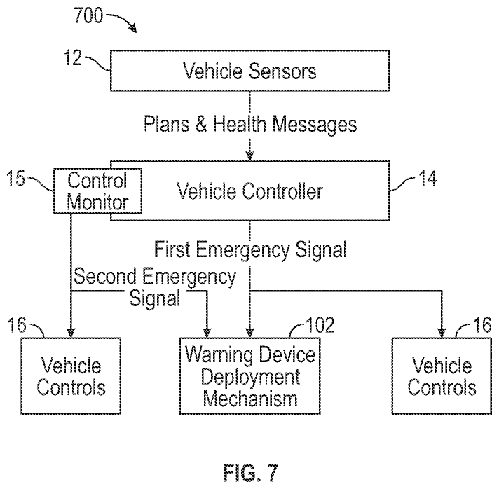

FIG. 7 is a block diagram of a warning device deployment control system 700, according to an embodiment of the present disclosure. The warning device deployment control system 700 can control aspects of the autonomous vehicle 10, such as the warning device deployment systems detailed herein. The warning device deployment control system 700 includes the vehicle sensors 12, the vehicle controller 14, the vehicle controls 16, and a warning device deployment mechanism (e.g., the warning device deployment mechanism 102 of FIG. 3). The vehicle sensors 12 and the vehicle controller 14 can include software and hardware for sensing, connecting, processing, analyzing, and decision making for the autonomous vehicle 10. The vehicle controller 14 can receive the sensor data and determine whether the vehicle sensors 12 or other components of the autonomous vehicle 10 are healthy (e.g., determines a health status).

The vehicle sensors 12, or other processing devices of the autonomous vehicle 10, generate health messages and send the health messages to the vehicle controller 14. For example, the health messages indicate whether the vehicle sensors 12 are healthy and operating normally (e.g., there are no faults in the vehicle sensors 12) or whether the vehicle sensors 12 are unhealthy (e.g., there is a fault in one or more vehicle sensors 12) or the vehicle sensors 12 are otherwise not operating within predetermined parameters, sensing within predetermined calibrated parameters, whether there are any software faults, etc. The faults can include a sensor being offline (e.g., not sending data to the vehicle controller 14), sensor data from one sensor does not match sensor data from a redundant sensor, or other components of the autonomous vehicle 10 (FIG. 1) are not operating as expected.

The vehicle controller 14 includes a control monitor 15 that monitors the status of the vehicle controller 14. The control monitor 15 can include a separate controller or processor that determines whether the vehicle controller 14 is healthy (e.g., operating normally) or unhealthy (e.g., not operating normally) or otherwise determines a health status of the vehicle controller 14. For example, the control monitor 15 can determine the vehicle controller 14 is unhealthy if the vehicle controller 14 is offline or otherwise not operating as expected (e.g., outside of predetermined parameters, software faults, etc.). When the vehicle controller 14 detects that a vehicle sensor 12 or other component of the autonomous vehicle 10 is unhealthy (e.g., receives a message that the component is unhealthy) and the vehicle controller 14 itself is healthy, the vehicle controller 14 generates a first emergency signal and executes a first emergency plan. The first emergency plan, also referred to as a fallback plan and/or fallback signal, includes controlling the vehicle controls 16 (e.g., brake, steering, and engine actuation) to stop and steer the autonomous vehicle 10 in the traffic lane 31 (FIG. 2) or in the shoulder 33 (FIG. 2). While the autonomous vehicle 10 is stopping, the vehicle controller 14 can control the warning device deployment mechanism 102 to deploy the warning devices, as detailed further below.

When a vehicle sensor 12 or other component of the autonomous vehicle 10 is unhealthy and the control monitor 15 determines that the vehicle controller 14 is unhealthy, the control monitor 15 generates a second emergency signal and executes a second emergency plan. The second emergency plan, also referred to as a fail-safe plan and/or a fail-safe signal, includes controlling the vehicle controls 16 (e.g., brake, steering, and engine actuation) to stop the autonomous vehicle 10 in the traffic lane 31. While the autonomous vehicle 10 is stopping, the control monitor 15 can control the warning device deployment mechanism 102 to deploy the warning devices. When the vehicle controller 14 is unhealthy, the vehicle controller 14 is unable to control the autonomous vehicle 10 to steer or otherwise navigate the autonomous vehicle 10. Thus, for safety, the control monitor 15 stops the autonomous vehicle 10 in the traffic lane 31 without steering or navigating the autonomous vehicle 10 to a shoulder 33.

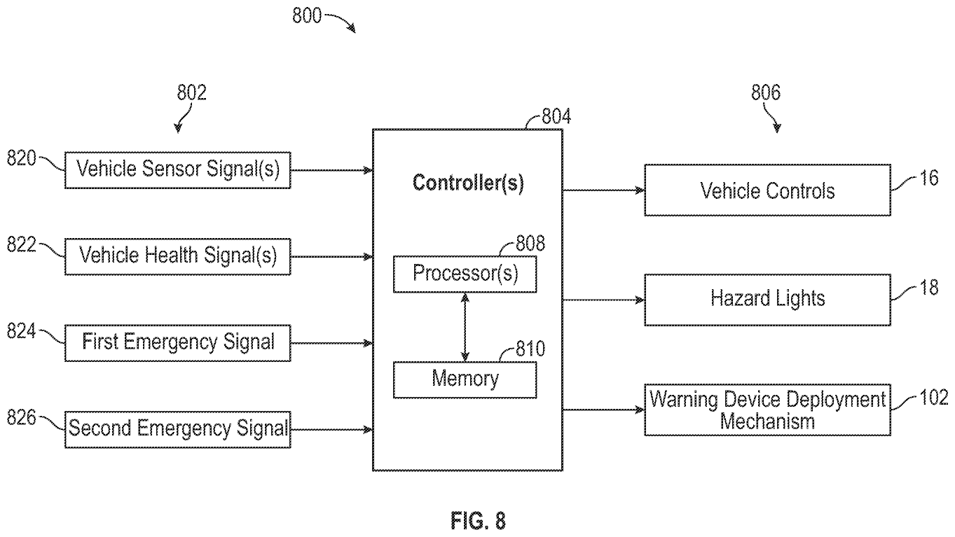

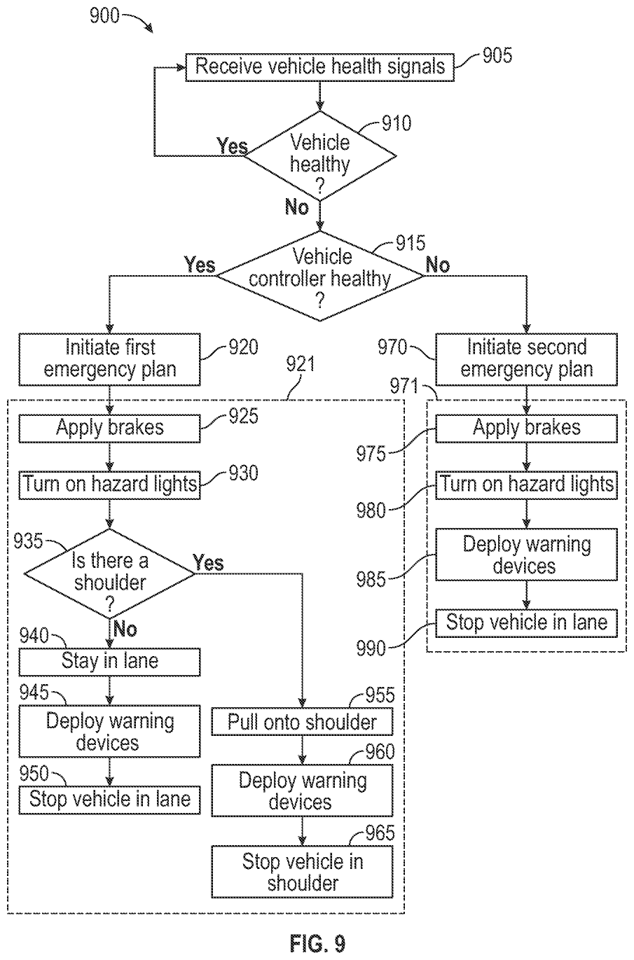

FIG. 8 is a block diagram of a warning device deployment control system 800, for operation and control of at least portions of the autonomous vehicle 10, according to an embodiment of the present disclosure. For clarity, reference will be made to the warning device deployment system 100 of FIGS. 1 to 3. The warning device deployment control system 800, however, can be used for any warning device deployment system detailed herein. The warning device deployment control system 800 includes inputs 802, one or more controllers 804, and outputs 806. The inputs 802 include one or more vehicle sensor signals 820 from the vehicle sensors 12, one or more vehicle health signals 822, a first emergency signal 824, and a second emergency signal 826. The outputs 806 include the vehicle controls 16, the hazard lights 18, and the warning device deployment mechanism 102. The one or more controllers 804 receive the inputs 802, implement a method of automatically deploying warning devices 104 for an autonomous vehicle 10, and control the outputs 806, as detailed with reference to FIG. 9 below.

The one or more controllers 804 may be one or more standalone controllers, such as the vehicle controller 14 (FIG. 1) and/or the control monitor 15. As depicted in FIGS. 2 to 5, the vehicle controller 14 and the control monitor 15 are separate components. In this embodiment, the one or more controllers 804 include a computing device having one or more processors 808 and a memory 810. The processors 808 can be any suitable processing device, including, but not limited to, a microprocessor, a microcontroller, an integrated circuit, a logic device, a programmable logic controller (PLC), an application specific integrated circuit (ASIC), or a Field Programmable Gate Array (FPGA). The memory 810 can include one or more computer-readable media, including, but not limited to, non-transitory computer-readable media, a computer readable non-volatile medium (e.g., a flash memory), a random access memory (RAM), a read-only memory (ROM), hard drives, flash drives, or other memory devices. A system bus couples the various components including the memory 810 to the processors 808. Portions of the one or more controllers 804 (e.g., portions of the processors 808 and/or the memory 810) may be stored on a network, such as a cloud computing network or the like.

The memory 810 can store information accessible by the processors 808, including computer-readable instructions that can be executed by the processors 808. The instructions can be any set of instructions or a sequence of instructions that, when executed by the processors 808, cause the processors 808 and the controller 804 to perform operations. The controller 804 and, more specifically, the processors 808 are programmed or configured to perform these operations, such as the operations discussed further below. In some embodiments, the instructions can be executed by the processors 808 to cause the processors 808 to complete any of the operations and functions for which the controller 804 is configured, as will be described further below. The instructions can be software written in any suitable programming language or can be implemented in hardware. Additionally, or alternatively, the instructions can be executed in logically or virtually separate threads on the processors 808. The memory 810 can further store data that can be accessed by the processors 808.

To enable user interaction with the one or more controllers 804, an input device represents any number of input mechanisms, such as a microphone for speech, a touch-sensitive screen for gesture or graphical input, keyboard, mouse, motion input, speech and so forth. The input device can be located anywhere (e.g., remote from the autonomous vehicle 10 or on the autonomous vehicle 10) and may communicate with the one or more controllers 804 by wired or wireless communication. The one or more controllers 804 can communicate with an output device. The output device can be one or more of a number of output mechanisms known to those of skill in the art, such as, for example, a display. In some instances, multimodal systems enable a user to provide multiple types of input to communicate with the one or more controllers 804. A communications interface generally governs and manages the user input and system output. There is no restriction on operating on any particular hardware arrangement and therefore the basic features here may easily be substituted for improved hardware or firmware arrangements as they are developed.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The one or more controllers 804 can include one or more communications interfaces for providing communication with the inputs 802 and the outputs 806. For example, the one or more controllers 804 can communicate with the inputs 802 and the outputs 806 through wired means or through wireless means (e.g., WiFi, cellular, satellite, Bluetooth, radio communications, etc.). In this way, the one or more controllers 804 are communicatively coupled to the vehicle sensors 12 (FIG. 1), to the vehicle controls 16, to the hazard lights 18, and to the warning device deployment mechanism 102. The vehicle sensor signals 820 include sensor data from each of the vehicle sensors 12. The vehicle health signals 822 include health data or health messages of the vehicle sensors 12 (FIG. 7) or other components of the autonomous vehicle 10. The first emergency signal 824 includes a signal generated by the vehicle controller 14 to execute a first emergency plan. The second emergency signal 826 includes a signal generated by the control monitor 15 to execute a second emergency plan. The vehicle controls 16 output includes actuation of the vehicle controls 16 to control operation and navigation of the autonomous vehicle 10. The hazard lights 18 output includes control of the hazard lights 18 to turn the hazard lights 18 on and off. The warning device deployment mechanism 102 output includes control of the warning device deployment mechanism 102 to deploy the warning devices (e.g., to open the door(s) of the warning device deployment mechanism 102. The one or more controllers 804 receive the inputs 802 and control the outputs 806, as detailed further below.

FIG. 9 is a flow diagram of a method 900 of automatically deploying warning devices for an autonomous vehicle 10, according to an embodiment of the present disclosure. Reference will be made to the warning device deployment system 100 of FIGS. 1 to 3 and the warning device deployment control system 800 of FIG. 8. The method 900, however, may also be used with the warning device deployment system 400 of FIG. 4. In step 905, the one or more controllers 804 receive the one or more vehicle health signals 822. For example, the one or more controllers 804 receive the one or more vehicle health signals 822 from one or more vehicle sensors 12 (FIG. 7) or from other components of the autonomous vehicle 10. In some examples, the one or more controllers 804 can receive the one or more vehicle sensor signals 820 and generate the one or more vehicle health signals 822 based on a health status of the one or more vehicle sensors 12. The one or more vehicle health signals 822 can include a health status of any of the components of the autonomous vehicle 10.

In step 910, the one or more controllers 804 determine whether the autonomous vehicle 10 is healthy. For example, the one or more vehicle health signals 822 can indicate whether the autonomous vehicle 10 is healthy. If the autonomous vehicle 10 is healthy (step 910: Yes), the one or more controllers 804 continue to receive the one or more vehicle health signals 822 (step 905).

If the autonomous vehicle 10 is unhealthy (step 910: No), the one or more controllers 804 determine whether the vehicle controller 14 is healthy (step 915). For example, the control monitor 15 determines whether vehicle controller 14 is healthy and operating normally.

If the vehicle controller 14 is healthy (step 915: Yes), the one or more controllers 804 initiate a first emergency plan 921 (step 920). For example, if a component (e.g., one or more vehicle sensors 12) is unhealthy and the vehicle controller 14 is healthy, the one or more controllers 804 generate or receive the first emergency signal 824 and initiate the first emergency plan 921. Accordingly, the one or more controllers 804 detect there is an emergency for the autonomous vehicle 10 in steps 910 and 915. The first emergency plan 921, also referred to as a fallback plan, includes steps 925-965 of the method 900, detailed below. The fallback plan includes the one or more controllers 804 generating a stopping path, also referred to as a fallback path, and stopping the autonomous vehicle 10, as detailed further below.

In step 925, the one or more controllers 804 apply the brakes of the autonomous vehicle 10. For example, the one or more controllers 804 control the vehicle controls 16 to apply the brakes to slow down and stop the autonomous vehicle 10.

In step 930, the one or more controllers 804 turn on the hazard lights 18. For example, the one or more controllers 804 control the hazard lights 18 to turn on the hazard lights 18. The one or more controllers 804 can turn on the hazard lights 18 simultaneously when the one or more controllers 804 apply the brakes to slow down and stop the autonomous vehicle 10.

In step 935, the one or more controllers 804 determine whether there is a shoulder 33 on the road 30. For example, the one or more controllers 804 can receive the vehicle sensor signals 820 and determine whether there is a should 33 on the road 30 based on the vehicle sensor signals 820. In some examples, one or more cameras can send a video feed of the road 30 to the one or more controllers 804, and the one or more controllers 804 can determine whether there is a shoulder 33 based on the video feed of the road 30. In some examples, the one or more controllers 804 can receive data from a GPS or from another road mapping service that indicates whether the road 30 has a shoulder 33.

If the road 30 does not have a shoulder (step 935: No), the one or more controllers 804 control the autonomous vehicle 10 to stay in the traffic lane 31 while the autonomous vehicle 10 is stopping (step 940). For example, the one or more controllers 804 can control the vehicle controls 16 to navigate the autonomous vehicle 10 to stay in the traffic lane 31 while the autonomous vehicle 10 stops. In some examples, the one or more controllers 804 can control the autonomous vehicle to navigate into a different traffic lane (e.g., a right-most traffic lane) while the autonomous vehicle 10 stops. Controlling the autonomous vehicle 10 includes determining and generating the fallback path to determine how to steer the autonomous vehicle 10, how to apply the brakes (e.g., how much brake force), etc. based on a curvature of the road, a slope (e.g., incline or decline) of the road, or objects in the road, as detailed further below.

In step 945, the one or more controllers 804 deploy the warning devices 104. The one or more controllers 804 control the warning device deployment mechanism 102 to deploy the warning devices 104. To deploy the warning device 104, the one or more controllers 804 can control the locking mechanism 510 (FIG. 5) to unlock the door 508 (FIG. 5) such that the door 508 opens and the warning devices 104 drop out of the warning device deployment mechanism 102 onto the road 30, as detailed above. The one or more controllers 804 control the warning device deployment mechanism 102 to deploy the warning devices 104 in a deployment sequence such that the warning devices 104 are deployed at predetermined distances behind the autonomous vehicle 10. The one or more controllers 804 can determine a current speed of the autonomous vehicle 10 when the one or more controllers 804 apply the brakes for the emergency (step 925). Based on the current speed and on the application of the brakes, the one or more controllers 804 can determine a stopping distance for the autonomous vehicle 10 to stop.

Based on the stopping distance, the one or more controllers 804 can determine a deployment sequence for deploying the one or more warning devices 104. The deployment sequence is an amount of time to deploy the warning devices 104 such that the warning devices 104 are deployed at the predetermined distances from the autonomous vehicle 10. The deployment sequence (e.g., the amount of time to deploy each warning device 104) is determined based on the stopping distance and speed of the autonomous vehicle 10. For example, the one or more controllers 804 can deploy the first warning device 104a at one second from the brakes being applied, deploy the second warning device 104b at five seconds from the brakes being applied, and deploy the third warning device 104c at 10 seconds from the brakes being applied. In this way, the one or more controllers 804 can deploy the warning devices 104 such that the warning devices 104 are deployed at the predetermined distances when the autonomous vehicle 10 is completely stopped. For example, based on the stopping distance, the one or more controllers 804 can deploy the first warning device 104a at a first predetermined distance, the second warning device 104b at a second predetermined distance, and the third warning device 104c at a third predetermined distance, as the autonomous vehicle 10 is stopping.

In some examples, the one or more controllers 804 can deploy the warning devices 104 based on a stopping maneuver of the autonomous vehicle 10. The one or more controllers 804 can determine a stopping maneuver of the autonomous vehicle 10 as the autonomous vehicle 10 is stopping or is about to stop based on the vehicle sensor signals 820. The one or more controllers 804 can determine a path (e.g., the fallback path) the autonomous vehicle 10 takes to stop. For example, the one or more controllers 804 can determine that the autonomous vehicle 10 will turn right while stopping, will turn left while stopping, will remain straight while stopping, or combinations thereof. In this way, the one or more controllers 804 determine a curvature of the road 30, determine a slope of the road 30, and determine whether there are objects in the road 30. Based on the stopping maneuver, the one or more controllers 804 can control the warning device deployment mechanism 102 to deploy the warning devices 104 as the autonomous vehicle 10 is stopping such that the warning devices 104 are deployed at the predetermined distances behind the autonomous vehicle 10 when the autonomous vehicle 10 is completely stopped.

In some examples, the one or more controllers 804 can deploy the warning devices 104 in a direction based on the stopping maneuver of the autonomous vehicle 10 and/or based on a traffic lane that the autonomous vehicle is stopping in. In this way, the deployment sequence includes a selection of which warning device 104 to deploy such that the warning devices 104 are deployed at a deployment angle (e.g., left, right, center) from the autonomous vehicle 10. For example, if the autonomous vehicle 10 is turning left, the one or more controllers 804 can deploy a rightmost warning device 104 (e.g., the fourth warning device 104d) first to ensure the warning devices 104 are deployed on a correct side of the autonomous vehicle 10 when the autonomous vehicle 10 is stopped. Accordingly, the one or more controllers 804 can sequence the deployment of the warning devices 104 to deploy the rightmost warning device 104 first as the autonomous vehicle 10 is turning and the leftmost warning device 104 last as the autonomous vehicle 10 is almost at a complete stop. In this way, the one or more controllers 804 ensure that the warning devices 104 are deployed at the same width location along the traffic lane 31 or along the shoulder 33. If the autonomous vehicle 10 is in a right lane or on a right shoulder of the road, the one or more controllers 804 can deploy the warning devices 104 to a left side of the autonomous vehicle 10.

In step 950, the one or more controllers 804 can stop the autonomous vehicle 10 in the traffic lane 31. Accordingly, when the autonomous vehicle 10 is in an emergency (e.g., the first emergency plan) and there is no shoulder, the one or more controllers 804 can control the autonomous vehicle 10 to stop in the traffic lane 31 that the autonomous vehicle 10 is currently in and to deploy the warning devices 104 as the autonomous vehicle 10 is stopping such that the warning devices 104 are deployed at the predetermined distances from the autonomous vehicle 10 when the autonomous vehicle 10 is completely stopped.

If there is a shoulder 33 (step 935: Yes), the one or more controllers 804 pull the autonomous vehicle 10 onto the shoulder 33 (step 955). For example, the one or more controllers 804 control the vehicle controls 16 (e.g., steering, engine, etc.) to navigate the autonomous vehicle 10 onto the shoulder 33. The one or more controllers 804 can receive the vehicle sensor signals 820 to safely navigate the autonomous vehicle 10 onto the shoulder 33.

In step 960, the one or more controllers 804 deploy the warning devices 104 as the autonomous vehicle 10 is stopping. For example, the one or more controllers 804 control the warning device deployment mechanism 102 to deploy the warning devices 104, as detailed above.

In step 965, the one or more controllers 804 stop the autonomous vehicle 10 in the shoulder 33. Accordingly, when the autonomous vehicle 10 is in an emergency (e.g., the first emergency plan) and there is a shoulder 33 on the road 30, the one or more controllers 804 can control the autonomous vehicle 10 to navigate the autonomous vehicle 10 onto the shoulder 33 and to deploy the warning devices 104 as the autonomous vehicle 10 is stopping such that the warning devices 104 are deployed at the predetermined distances from the autonomous vehicle when the autonomous vehicle 10 is completely stopped.

In some instances, the vehicle controller 14 can also fail or otherwise become faulty. In such instances, the autonomous vehicle 10 is unable to operate autonomously as the vehicle controller 14 is unable to determine the location of the autonomous vehicle 10, determine the travel trajectory of the autonomous vehicle 10, detect the environment around the autonomous vehicle 10, detect other objects (e.g., other vehicles) around the autonomous vehicle 10, or the like. Accordingly, if the vehicle controller is unhealthy (step 915: No), the one or more controllers 804 (e.g., the control monitor 15) initiate a second emergency plan 971 (step 970). For example, if a component (e.g., one or more vehicle sensors 12) is unhealthy and the vehicle controller 14 is unhealthy, the one or more controllers 804 generate or receive the second emergency signal 826 and initiate the second emergency plan 971. The second emergency plan 971, also referred to as a fail-safe plan, includes steps 975-990 of the method 900, detailed below. In some examples, the one or more controllers 804 can initiate the second emergency plan 971 even if the vehicle sensors 12 are healthy, and only the vehicle controller 14 is unhealthy.

In step 975, the one or more controllers 804 apply the brakes of the autonomous vehicle 10. For example, the one or more controllers 804 control the vehicle controls 16 to apply the brakes to slow down and stop the autonomous vehicle 10.

In step 980, the one or more controllers 804 turn on the hazard lights 18. For example, the one or more controllers 804 control the hazard lights 18 to turn on the hazard lights 18. The one or more controllers 804 can turn on the hazard lights 18 simultaneously when the one or more controllers 804 apply the brakes to slow down and stop the autonomous vehicle 10.

In step 985, the one or more controllers 804 deploy the warning devices. The one or more controllers 804 control the warning device deployment mechanism 102 to deploy the warning devices 104 at the predetermined distances, as detailed above.

The second emergency plan 971 does not include a determination of whether there is a shoulder on the road as the vehicle controller 14 is unable to safely navigate the autonomous vehicle 10 when the vehicle controller 14 is unhealthy. Accordingly, in step 990, the second emergency plan 971 includes the one or more controllers 804 stopping the autonomous vehicle 10 in the traffic lane 31 that the autonomous vehicle 10 is currently in. Accordingly, when the autonomous vehicle 10 is in an emergency due to the vehicle controller 14 being unhealthy (e.g., the second emergency plan), the one or more controllers 804 (e.g., the control monitor 15) can control the autonomous vehicle 10 to stop in the traffic lane 31 that the autonomous vehicle 10 is currently in and to deploy the warning devices 104 as the autonomous vehicle 10 is stopping such that the warning devices 104 are deployed at the predetermined distances from the autonomous vehicle 10 when the autonomous vehicle 10 is completely stopped.

The autonomous vehicle 10 can remain stopped with the warning devices 104 deployed behind the autonomous vehicle 10 until the emergency is resolved. A human operator or technician can be deployed to the autonomous vehicle 10 to troubleshoot the emergency and fix the fault that caused the emergency. For example, the operator can reboot the autonomous vehicle 10, can fix the faulty sensors, can fix the faulty vehicle controller, or otherwise can fix the emergency that caused the autonomous vehicle 10 to enter the emergency plan and stop the autonomous vehicle 10. When the emergency has been resolved, the autonomous vehicle 10 will no longer detect an emergency and the autonomous vehicle 10 can then operate autonomously again. The operator can load the warning devices 104 back into the warning device deployment mechanism 102, as detailed above, such that the warning devices 104 can be deployed again if needed. In some examples, the autonomous vehicle 10 can automatically pick up and load the warning devices 104 back into the warning device deployment mechanism 102, as detailed above. The autonomous vehicle 10 can then operate normally and continue to operate autonomously.

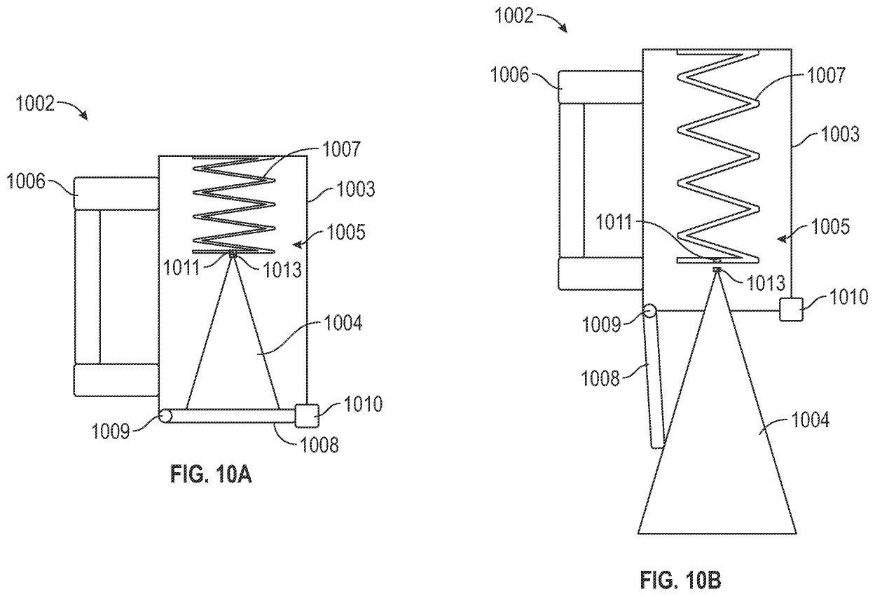

FIG. 10A illustrates a schematic view of a warning device deployment mechanism 1002 for a warning device deployment system in a stored state, according to another embodiment of the present disclosure. The warning device deployment mechanism 1002 can be used for any of the warning device deployment systems detailed herein. The warning device deployment mechanism 1002 includes many of the same or similar components as the warning device deployment mechanism 502 (FIGS. 5A and 5B). For example, the warning device deployment mechanism 1002 includes a storage container 1003 that includes an attachment device 1006 for attaching the warning device deployment mechanism 1002 to the autonomous vehicle 10 (FIGS. 1 to 4). In FIGS. 10A and 10B, a portion of the storage container 1003 is removed such that the interior 1005 is shown. The storage container 1003 also includes a biasing member 1007, a door 1008, a hinge 1009, and a locking mechanism 1010.

In the embodiment of FIGS. 10A and 10B, the warning device deployment mechanism 1002 includes a magnet 1011 disposed inside the storage container 1003. For example, the magnet 1011 is coupled to the biasing member 1007. The warning device 1004 also includes a magnet 1013 attached thereto. The magnet 1013 of the warning device 1004 interacts with the magnet 1011 of the storage container 1003 to attach the warning device 1004 to the storage container 1003, as detailed further below. When the autonomous vehicle 10 encounters an emergency, the autonomous vehicle 10 can deploy the warning device 1004.

FIG. 10B illustrates a schematic view of the warning device deployment mechanism 1002 in a deploying state, according to an embodiment of the present disclosure. To deploy the warning device 1004, the vehicle controller 14 controls the locking mechanism 1010 to unlock and the door 1008 pivots about the hinge 1009 and swings open. When the door 1008 opens, the biasing member 1007 extends and releases the stored mechanical energy. In this way, the biasing member 1007 ejects or otherwise deploys the warning device 1004 from the interior 1005 of the storage container 1003. The force of the biasing member 1007 expanding overcomes the force of the magnet 1011 and the magnet 1013 such that the warning device 1004 is released from the magnet 1011 when the warning device 1004 is deployed.

The warning device deployment system can pick up the warning device 1004 by the magnet 1013 when the warning device 1004 is no longer needed to be deployed (e.g., when the emergency has been resolved). For example, the autonomous vehicle 10 (FIG. 1) can reverse and align the warning device deployment mechanism 1002 over the warning device 1004 such that the magnetic field between the magnet 1011 and the magnet 1013 pulls, picks up, or otherwise lifts the warning device 1004 back into the storage container 1003. The warning device 1004 can compress such that the warning device 1004 fits into the storage container 1003. The autonomous vehicle 10 can then close and lock the door 1008 such that the warning device 1004 can be stored and ready to be used again if needed. Accordingly, the autonomous vehicle 10 can automatically pick up the warning device 1004 without the need of a human operator. In some examples, a human operator can manually pick up the warning device 1004 and insert the warning device 1004 back into the warning device deployment mechanism 1002 when the emergency has been resolved. In some examples, the autonomous vehicle 10 can include another device that picks up the warning device 1004 and inserts the warning device 1004 into the storage container 1003. In some examples, another vehicle and/or another device can pick up the warning device 1004 when the emergency has been resolved.

The systems and methods detailed herein provide for automatically deploying warning devices from an autonomous vehicle. The autonomous vehicle, via the one or more controllers, can deploy the warning devices from the warning device deployment mechanism in a sequence to deploy the warning devices at predetermined distances from the autonomous vehicle. The systems and methods of the present disclosure provide for deploying warning devices without the need of a human to be present at the autonomous vehicle. The warning device deployment mechanisms disclosed herein provide for an improved mechanism for storing and deploying warning devices such that the warning devices can be quickly deployed from the autonomous vehicle in a sequence and in any direction from the autonomous vehicle as needed. Accordingly, the systems and methods herein can provide for an improved warning device deployment system that deploys warning devices in a timely manner and at required distances from the autonomous vehicle to provide warnings to other road uses, and, thus, improves road safety when the autonomous vehicle is in an emergency. Further, the warning devices disclosed are compactable and expandable such that the warning devices can be stored in the warning device deployment mechanisms and provide stability for ensuring that the warning devices stand upright when deployed.

Further aspects of the present disclosure are provided by the subject matter of the following clauses.

A warning device deployment system for an autonomous vehicle. The warning device deployment system comprising one or more warning device deployment mechanisms attached to the autonomous vehicle and one or more warning devices stored in the one or more warning device deployment mechanisms. The one or more warning devices are deployed from the one or more warning device deployment mechanisms when the autonomous vehicle is in an emergency.

The warning device deployment system of the preceding clause, the one or more warning device deployment mechanisms including one or more storage containers for storing the one or more warning devices.

The warning device deployment system of any preceding clause, the one or more warning device deployment mechanisms including a door that opens to deploy the one or more warning devices.

The warning device deployment system of any preceding clause, the one or more warning device deployment mechanisms including a locking mechanism to lock the door when the one or more warning devices are stored in the one or more warning device deployment mechanisms.

The warning device deployment system of any preceding clause, the one or more warning device deployment mechanisms including a biasing member that pushes the one or more warning devices out of the one or more warning device deployment mechanisms to deploy the one or more warning devices.

The warning device deployment system of any preceding clause, the one or more warning devices being compressed inside the one or more warning device deployment mechanisms when the one or more warning devices are stored in the one or more warning device deployment mechanisms.

The warning device deployment system of any preceding clause, the one or more warning devices expanding when the one or more warning devices are deployed from the one or more warning device deployment mechanisms.

The warning device deployment system of any preceding clause, the one or more warning device deployment mechanisms being attached to a rear end of the autonomous vehicle.

The warning device deployment system of any preceding clause, further comprising a vehicle controller of the autonomous vehicle, the vehicle controller in communication with the one or more warning device deployment mechanisms to deploy the one or more warning devices from the one or more warning device deployment mechanisms.

The warning device deployment system of any preceding clause, the one or more warning device deployment mechanisms being attached to the autonomous vehicle by one or more attachment devices.

An autonomous vehicle comprising a warning device deployment system. The warning device deployment system comprising one or more warning device deployment mechanisms attached to the autonomous vehicle, and one or more warning devices stored in the one or more warning device deployment mechanisms. The one or more warning devices being deployed from the one or more warning device deployment mechanisms when the autonomous vehicle is in an emergency.

The autonomous vehicle of the preceding clause, the one or more warning device deployment mechanisms including one or more storage containers for storing the one or more warning devices.

The autonomous vehicle of any preceding clause, the one or more warning device deployment mechanisms including a door that opens to deploy the one or more warning devices.

The autonomous vehicle of any preceding clause, the one or more warning device deployment mechanisms including a locking mechanism to lock the door when the one or more warning devices are stored in the one or more warning device deployment mechanisms.

The autonomous vehicle of any preceding clause, the one or more warning device deployment mechanisms including a biasing member that pushes the one or more warning devices out of the one or more warning device deployment mechanisms to deploy the one or more warning devices.

The autonomous vehicle of any preceding clause, the one or more warning devices being compressed inside the one or more warning device deployment mechanisms when the one or more warning devices are stored in the one or more warning device deployment mechanisms.

The autonomous vehicle of any preceding clause, the one or more warning devices expanding when the one or more warning devices are deployed from the one or more warning device deployment mechanisms.

The autonomous vehicle of any preceding clause, the one or more warning device deployment mechanisms being attached to a rear end of the autonomous vehicle.

The autonomous vehicle of any preceding clause, further comprising a vehicle controller of the autonomous vehicle, the vehicle controller in communication with the one or more warning device deployment mechanisms to deploy the one or more warning devices from the one or more warning device deployment mechanisms.

The autonomous vehicle of any preceding clause, the one or more warning device deployment mechanisms being attached to the autonomous vehicle by one or more attachment devices.

A method of automatically deploying warning devices for an autonomous vehicle, the method comprising: automatically stopping the autonomous vehicle when there is an emergency, and automatically deploying one or more warning devices from one or more warning device deployment mechanisms attached to the autonomous vehicle while the autonomous vehicle is stopping such that the one or more warning devices drop from the one or more warning device deployment mechanisms.

The method of the preceding clause, further comprising: determining whether a vehicle controller of the autonomous vehicle is healthy; upon a determination that the vehicle controller is health, initiating a first emergency plan; and upon a determination that the vehicle controller is unhealthy, initiating a second emergency plan, the second emergency plan being different than the first emergency plan.

The method of any preceding clause, the first emergency plan comprising: determining whether there is a shoulder of a road on which the autonomous vehicle is operating; upon a determination that there is a shoulder, automatically navigating the autonomous vehicle onto the shoulder while the autonomous vehicle is stopping; and automatically deploying the one or more warning devices in the shoulder.

The method of any preceding clause, further comprising: upon a determination that there is no shoulder of the road, automatically stopping the autonomous vehicle in a traffic lane of the road; and automatically deploying the one or more warning devices in the traffic lane.

The method of any preceding clause, the second emergency plan comprising: automatically stopping the autonomous vehicle in a current traffic lane in which the autonomous vehicle is operating; and automatically deploying the one or more warning devices in the current traffic lane.

The method of any preceding clause, further comprising automatically deploying the one or more warning devices in a deployment sequence such that the one or more warning devices are deployed at predetermined distances from the autonomous vehicle when the autonomous vehicle comes to a complete stop.

The method of any preceding clause, further comprising: determining a stopping maneuver of the autonomous vehicle; and automatically deploying the one or more warning devices at a deployment angle from the autonomous vehicle based on the stopping maneuver.

The method of any preceding clause, further comprising detecting an emergency for the autonomous vehicle prior to automatically stopping the autonomous vehicle.

The method of any preceding clause, the automatically deploying the one or more warning devices from the one or more warning device deployment mechanisms including automatically deploying the one or more warning devices such that the one or more warning devices drop from the one or more warning device deployment mechanisms onto a road on which the autonomous vehicle is operating.

A system for automatically deploying warning devices for an autonomous vehicle. The system comprising one or more warning device deployment mechanisms attached to the autonomous vehicle, one or more warning devices stored in the one or more warning device deployment mechanisms, and one or more controllers configured to: automatically stop the autonomous vehicle when there is an emergency; and automatically deploy the one or more warning devices from the one or more warning device deployment mechanisms while the autonomous vehicle is stopping such that the one or more warning devices drop from the one or more warning device deployment mechanisms.

The system of the preceding clause, the one or more controllers including a vehicle controller of the autonomous vehicle, and the one or more controllers being further configured to: determine whether the vehicle controller is healthy; upon a determination that the vehicle controller is healthy, initiate a first emergency plan; and upon a determination that the vehicle controller is unhealthy, initiate a second emergency plan, the second emergency plan being different than the first emergency plan.

The system of any preceding clause, the first emergency plan including the one or more controllers configured to: determine whether there is a shoulder of a road on which the autonomous vehicle is operating; upon a determination that there is a shoulder, automatically navigate the autonomous vehicle onto the shoulder while the autonomous vehicle is stopping; and automatically deploy the one or more warning devices in the shoulder.

The system of any preceding clause, the one or more controllers being configured to: upon a determination that there is no shoulder of the road, automatically stop the autonomous vehicle in a traffic lane of the road; and automatically deploy the one or more warning devices in the traffic lane.

The system of any preceding clause, the second emergency plan including the one or more controllers configured to: automatically stop the autonomous vehicle in a current traffic lane in which the autonomous vehicle is operating; and automatically deploy the one or more warning devices in the current traffic lane.

The system of any preceding clause, the one or more controllers being configured to: automatically deploy the one or more warning devices in a deployment sequence such that the one or more warning devices are deployed at predetermined distances from the autonomous vehicle when the autonomous vehicle comes to a complete stop.

The system of any preceding clause, the one or more controllers being configured to: determine a stopping maneuver of the autonomous vehicle; and automatically deploy the one or more warning devices at a deployment angle from the autonomous vehicle based on the stopping maneuver.

The system of any preceding clause, the one or more controllers being configured to detect an emergency for the autonomous vehicle prior to automatically stopping the autonomous vehicle.

The system of any preceding clause, the one or more controllers being configured to automatically deploy the one or more warning devices such that the one or more warning devices drop from the one or more warning device deployment mechanisms onto a road on which the autonomous vehicle is operating.

An autonomous vehicle comprising a warning device deployment system. The warning device deployment system comprising one or more warning device deployment mechanisms attached to the autonomous vehicle, one or more warning devices stored in the one or more warning device deployment mechanisms, and one or more controllers configured to: automatically stop the autonomous vehicle when there is an emergency; and automatically deploy the one or more warning devices from the one or more warning device deployment mechanisms while the autonomous vehicle is stopping such that the one or more warning devices drop from the one or more warning device deployment mechanisms.

The autonomous vehicle of the preceding clause, the one or more controllers including a vehicle controller of the autonomous vehicle, and the one or more controllers being further configured to: determine whether the vehicle controller is healthy; upon a determination that the vehicle controller is health, initiate a first emergency plan; and upon a determination that the vehicle controller is unhealthy, initiate a second emergency plan, the second emergency plan being different than the first emergency plan.

The autonomous vehicle of any preceding clause, the first emergency plan including the one or more controllers configured to: determine whether there is a shoulder of a road on which the autonomous vehicle is operating; upon a determination that there is a shoulder, automatically navigate the autonomous vehicle onto the shoulder while the autonomous vehicle is stopping; and automatically deploy the one or more warning devices in the shoulder.

The autonomous vehicle of any preceding clause, the one or more controllers being configured to: upon a determination that there is no shoulder of the road, automatically stop the autonomous vehicle in a traffic lane of the road; and automatically deploy the one or more warning devices in the traffic lane.

The autonomous vehicle of any preceding clause, the second emergency plan including the one or more controllers configured to: automatically stop the autonomous vehicle in a current traffic lane in which the autonomous vehicle is operating; and automatically deploy the one or more warning devices in the current traffic lane.

The autonomous vehicle of any preceding clause, the one or more controllers being configured to: automatically deploy the one or more warning devices in a deployment sequence such that the one or more warning devices are deployed at predetermined distances from the autonomous vehicle when the autonomous vehicle comes to a complete stop.

The autonomous vehicle of any preceding clause, the one or more controllers being configured to: determine a stopping maneuver of the autonomous vehicle; and automatically deploy the one or more warning devices at a deployment angle from the autonomous vehicle based on the stopping maneuver.

The autonomous vehicle of any preceding clause, the one or more controllers being configured to detect an emergency for the autonomous vehicle prior to automatically stopping the autonomous vehicle.

The autonomous vehicle of any preceding clause, the one or more controllers being configured to automatically deploy the one or more warning devices such that the one or more warning devices drop from the one or more warning device deployment mechanisms onto a road on which the autonomous vehicle is operating.

A warning device for a warning device deployment system for an autonomous vehicle. The warning device comprising a tetrahedron frame having four triangular faces, and at least one reflective material on the tetrahedron frame. The tetrahedron frame defining an expanded shape of the warning device. The warning device being self-expandable such that the warning device is compactable to a reduced volume when the warning device is stored in the warning device deployment system and expandable to the expanded shape when the warning device is deployed from the warning device deployment system.

The warning device of the preceding clause, the warning device being made from a viscoelastic material.

The warning device of any preceding clause, the tetrahedron frame including a base such that the warning device stands upright from the base in the expanded shape.

The warning device of any preceding clause, the base being weighted to provide stability for the warning device when the warning device is deployed from the warning device deployment system.

The warning device of any preceding clause, the base having one or more weights disposed therein.

The warning device of any preceding clause, the one or more weights being disposed in one or more vertices of the base.

The warning device of any preceding clause, further including a magnet disposed in the warning device such that the warning device is picked up by a corresponding magnet of the warning device deployment system.

A warning device deployment system for an autonomous vehicle. The warning device deployment system comprising one or more warning device deployment mechanisms attached to the autonomous vehicle, and one or more warning devices stored in the one or more warning device deployment mechanisms. The one or more warning devices being deployed from the one or more warning device deployment mechanisms, the one or more warning devices comprising a tetrahedron frame having four triangular faces, and at least one reflective material on the tetrahedron frame. The tetrahedron frame defining an expanded shape of the one or more warning devices. The one or more warning devices being self-expandable such that the one or more warning devices are compactable to a reduced volume when the one or more warning devices are stored in the one or more warning device deployment mechanisms and expandable to the expanded shape when the one or more warning devices are deployed from the one or more warning device deployment mechanisms.

The warning device deployment system of the preceding clause, the one or more warning devices being made from a viscoelastic material.

The warning device deployment system of any preceding clause, the tetrahedron frame including a base such that the one or more warning devices stand upright from the base in the expanded shape.

The warning device deployment system of any preceding clause, the base being weighted to provide stability for the one or more warning devices when the one or more warning devices are deployed from the one or more warning device deployment mechanisms.

The warning device deployment system of any preceding clause, the base having one or more weights disposed therein.

The warning device deployment system of any preceding clause, the one or more weights being disposed in one or more vertices of the base.

The warning device deployment system of any preceding clause, the one or more warning device deployment mechanisms including a magnet disposed therein, and the one or more warning devices including a magnet disposed therein such that the one or more warning devices are picked up by the magnet of the one or more warning device deployment mechanisms.

An autonomous vehicle comprising one or more warning device deployment mechanisms attached to the autonomous vehicle, and one or more warning devices stored in the one or more warning device deployment mechanisms. The one or more warning devices being deployed from the one or more warning device deployment mechanisms. The one or more warning devices comprising a tetrahedron frame having four triangular faces, and at least one reflective material on the tetrahedron frame. The tetrahedron frame defining an expanded shape of the warning device. The one or more warning devices being self-expandable such that the one or more warning devices are compactable to a reduced volume when the one or more warning devices are stored in the one or more warning device deployment mechanisms and expandable to the expanded shape when the one or more warning devices are deployed from the one or more warning device deployment mechanisms.

The autonomous vehicle of the preceding clause, the one or more warning devices being made from a viscoelastic material.

The autonomous vehicle of any preceding clause, the tetrahedron frame including a base such that the one or more warning devices stand upright from the base in the expanded shape.

The autonomous vehicle of any preceding clause, the base being weighted to provide stability for the one or more warning devices when the one or more warning devices are deployed from the one or more warning device deployment mechanisms.

The autonomous vehicle of any preceding clause, the base having one or more weights disposed therein.

The autonomous vehicle of any preceding clause, the one or more weights being disposed in one or more vertices of the base.

Although the foregoing description is directed to the preferred embodiments, it is noted that other variations and modifications will be apparent to those skilled in the art and may be made without departing from the spirit or scope of the disclosure. Moreover, features described in connection with one embodiment may be used in conjunction with other embodiments, even if not explicitly stated above.

1. A warning device for a warning device deployment system for an autonomous vehicle, the warning device comprising:
a tetrahedron frame having four triangular faces, the tetrahedron frame defining an expanded shape of the warning device;
at least one reflective material on the tetrahedron frame, wherein the warning device is self-expandable such that the warning device is compactable to a reduced volume when the warning device is stored in the warning device deployment system and expandable to the expanded shape when the warning device is deployed from the warning device deployment system.

2. The warning device of claim 1, wherein the warning device is made from a viscoelastic material.

3. The warning device of claim 1, wherein the tetrahedron frame includes a base such that the warning device stands upright from the base in the expanded shape.

4. The warning device of claim 3, wherein the base is weighted to provide stability for the warning device when the warning device is deployed from the warning device deployment system.

5. The warning device of claim 4, wherein the base has one or more weights disposed therein.

6. The warning device of claim 5, wherein the one or more weights are disposed in one or more vertices of the base.

7. The warning device of claim 1, further including a magnet disposed in the warning device such that the warning device is picked up by a corresponding magnet of the warning device deployment system.

8. A warning device deployment system for an autonomous vehicle, the warning device deployment system comprising:
one or more warning device deployment mechanisms attached to the autonomous vehicle; and
one or more warning devices stored in the one or more warning device deployment mechanisms, the one or more warning devices being deployed from the one or more warning device deployment mechanisms, the one or more warning devices comprising:
a tetrahedron frame having four triangular faces, the tetrahedron frame defining an expanded shape of the one or more warning devices;
at least one reflective material on the tetrahedron frame, wherein the one or more warning devices are self-expandable such that the one or more warning devices are compactable to a reduced volume when the one or more warning devices are stored in the one or more warning device deployment mechanisms and expandable to the expanded shape when the one or more warning devices are deployed from the one or more warning device deployment mechanisms.

9. The warning device deployment system of claim 8, wherein the one or more warning devices are made from a viscoelastic material.

10. The warning device deployment system of claim 8, wherein the tetrahedron frame includes a base such that the one or more warning devices stand upright from the base in the expanded shape.

11. The warning device deployment system of claim 10, wherein the base is weighted to provide stability for the one or more warning devices when the one or more warning devices are deployed from the one or more warning device deployment mechanisms.

12. The warning device deployment system of claim 11, wherein the base has one or more weights disposed therein.

13. The warning device deployment system of claim 12, wherein the one or more weights are disposed in one or more vertices of the base.

14. The warning device deployment system of claim 8, wherein the one or more warning device deployment mechanisms include a magnet disposed therein, and the one or more warning devices include a magnet disposed therein such that the one or more warning devices are picked up by the magnet of the one or more warning device deployment mechanisms.

15. An autonomous vehicle comprising:
one or more warning device deployment mechanisms attached to the autonomous vehicle; and
one or more warning devices stored in the one or more warning device deployment mechanisms, the one or more warning devices being deployed from the one or more warning device deployment mechanisms, the one or more warning devices comprising:
a tetrahedron frame having four triangular faces, the tetrahedron frame defining an expanded shape of the warning device;
at least one reflective material on the tetrahedron frame, wherein the one or more warning devices are self-expandable such that the one or more warning devices are compactable to a reduced volume when the one or more warning devices are stored in the one or more warning device deployment mechanisms and expandable to the expanded shape when the one or more warning devices are deployed from the one or more warning device deployment mechanisms.

16. The autonomous vehicle of claim 15, wherein the one or more warning devices are made from a viscoelastic material.

17. The autonomous vehicle of claim 15, wherein the tetrahedron frame includes a base such that the one or more warning devices stand upright from the base in the expanded shape.

18. The autonomous vehicle of claim 17, wherein the base is weighted to provide stability for the one or more warning devices when the one or more warning devices are deployed from the one or more warning device deployment mechanisms.

19. The autonomous vehicle of claim 18, wherein the base has one or more weights disposed therein.

20. The autonomous vehicle of claim 19, wherein the one or more weights are disposed in one or more vertices of the base.
